(19) United States
(12) Patent Application Publication
(10) Pub. No.: US 2026/0228367 A1
(43) Pub. Date: Aug. 6, 2026

(54) SEMICONDUCTOR DEVICE

(71) Applicant: Renesas Electronics Corporation, Tokyo (JP)

(72) Inventors: Yukihiro KISHIDA, Tokyo (JP); Masashi ASO, Tokyo (JP); Hajime EGUCHI, Tokyo (JP)

(21) Appl. No.: 19/450,375

(22) Filed: Jan. 15, 2026

(30) Foreign Application Priority Data
Feb. 6, 2025 (JP) 2025-018572

(51) Int. Cl. G06F 21/75; G06F 21/55

(52) U.S. Cl. CPC G06F 21/755; G06F 21/554

(57) ABSTRACT

Enhance the security resistance of semiconductor memory devices against voltage glitches. The glitch detection circuit outputs a glitch detection signal when it detects voltage fluctuations. The post-detection control circuit outputs a reset request signal requesting the reset operation of the semiconductor device or an interrupt request signal for the processing of the processor when the glitch detection signal is output from the glitch detection circuit.

### CROSS-REFERENCE TO RELATED APPLICATIONS

The disclosure of Japanese Patent Application No. 2025-018572 filed on February 6, 2025, including the specification, drawings and abstract is incorporated herein by reference in its entirety.

### BACKGROUND

The present disclosure relates to a semiconductor device, particularly to a semiconductor device with measures against voltage glitches.

Cybersecurity measures against glitch attacks are becoming a concern. One example of a glitch attack is known to cause fluctuations in the voltage supplied to a semiconductor device. Specifically, a glitch attack is known to fluctuate the power supply voltage in a positive or negative direction during system or program startup, allowing unauthorized software to operate by bypassing security checks.

There are disclosed techniques listed below.

[Patent Document 1] Japanese Unexamined Patent Application Publication No. 2002-334317

Patent Document 1 discloses a countermeasure against glitch attacks on information processing devices by continuously describing conditional branch instructions multiple times, so that if a glitch attack occurs and a certain conditional branch instruction is not executed correctly, it effectively addresses the situation where the instruction was not executed.

### SUMMARY

In recent years, as glitch attack techniques have improved, there is concern that measures like those in Patent Document 1, which involve devising software processing, may be insufficient to correctly execute security checks even when a glitch attack occurs. In particular, it is required to ensure security resilience against voltage glitches that cause fluctuations in the power supply voltage to semiconductor devices (chips), not only during program startup but also after program startup.

The present disclosure is made to solve the above problems and provides a semiconductor memory device with enhanced security resilience against voltage glitches.

Other objects and novel features will become apparent from the description of this specification and the accompanying drawings.

A semiconductor device according to one embodiment outputs a reset request signal for the semiconductor device or an interrupt request signal for processor processing in response to the detection of a voltage glitch using a voltage fluctuation circuit configured to change the output from the initial value after reset release upon detecting voltage fluctuations.

According to the above embodiment, it is possible to provide a semiconductor device capable of improving security resilience against voltage glitches

### BRIEF DESCRIPTION OF THE DRAWINGS

FIG. 1 is a flowchart illustrating security processing according to a comparative example.

FIG. 2 is a flowchart illustrating security processing according to the present disclosure.

FIG. 3 is a block diagram illustrating the configuration of the main parts for voltage glitch countermeasures in a semiconductor device according to the present disclosure.

FIG. 4 is a conceptual diagram illustrating the operation of the glitch detection circuit and post-detection control circuit according to the present disclosure.

FIG. 5 is a block diagram illustrating a configuration example of a semiconductor device according to the first embodiment.

FIG. 6 is a conceptual diagram illustrating a first configuration example of the glitch detection circuit shown in FIG. 5.

FIG. 7 is a conceptual diagram illustrating a second configuration example of the glitch detection circuit shown in FIG. 5.

FIG. 8 is a circuit diagram illustrating a configuration example of the glitch detection F/F shown in FIG. 6.

FIG. 9 is a circuit diagram illustrating a configuration example of the glitch detection F/F shown in FIG. 7.

FIG. 10 is a block diagram illustrating a configuration example of a semiconductor device according to a modified example of the first embodiment.

FIG. 11 is a conceptual diagram illustrating a first configuration example of the glitch detection circuit shown in FIG. 10.

FIG. 12 is a conceptual diagram illustrating a second configuration example of the glitch detection circuit shown in FIG. 10.

FIG. 13 is a circuit diagram illustrating a configuration example of the glitch detection F/F shown in FIG. 11.

FIG. 14 is a circuit diagram illustrating a configuration example of the glitch detection F/F shown in FIG. 12.

FIG. 15 is a flowchart illustrating security processing according to the second embodiment.

FIG. 16 is a block diagram illustrating a configuration example of a semiconductor device according to the second embodiment.

FIG. 17 is a conceptual diagram illustrating a configuration example of the glitch detection circuit shown in FIG. 16.

FIG. 18 is a block diagram illustrating a configuration example of a semiconductor device according to a modified example of the second embodiment.

FIG. 19 is a conceptual diagram illustrating a configuration example of the glitch detection circuit shown in FIG. 17.

### DETAILED DESCRIPTION

Hereinafter, each embodiment will be described in detail with reference to the drawings. Note that the same reference numerals are assigned to the same or equivalent parts, and their descriptions will not be repeated.

### Description of Comparative Example

First, a comparative example of security processing in a semiconductor device at the time of reset release to counter voltage glitch attacks will be described.

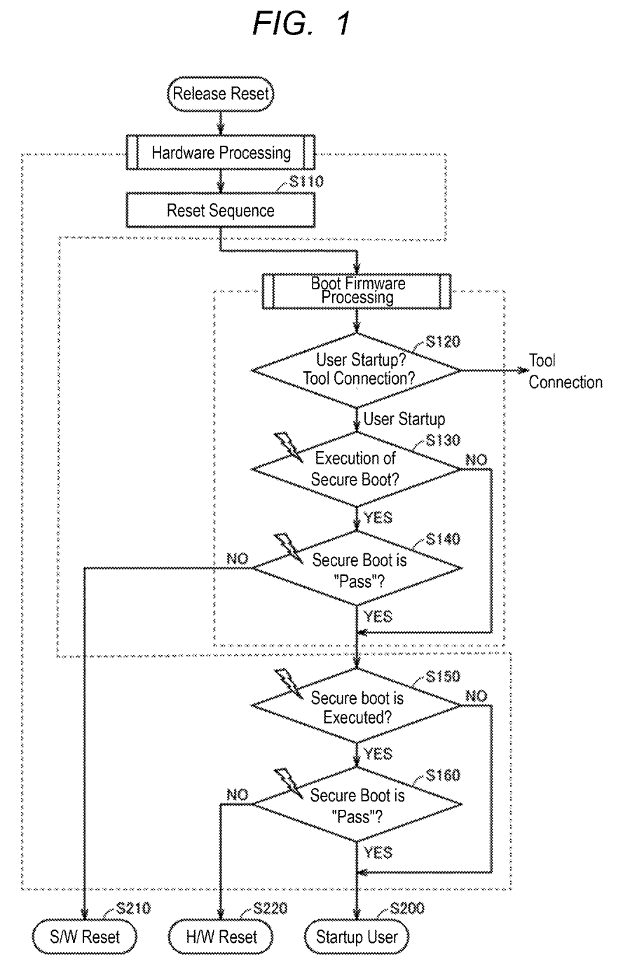

FIG. 1 is a flowchart illustrating security processing according to a comparative example. The security processing in FIG. 1 is executed at the time of user program startup upon reset release (hereinafter simply referred to as "user startup").

Referring to FIG. 1, the security processing according to the comparative example is executed by a combination of hardware processing in steps (hereinafter simply referred to as "S") 110, S150, S160, and software processing in S120 to S140. The software processing is executed by a processor such as a CPU (Central Processing Unit) mounted on the semiconductor device.

In the semiconductor device, when the reset is released, a predetermined reset sequence is executed by S110. As a result, a data value ("0" or "1" in binary) instructing the execution of a secure boot for security functions is written to a secure flip-flop (hereinafter also referred to as "secure F/F"), which will be described later.

In the semiconductor device, after the execution of the reset sequence in S110, or in parallel with the reset sequence, boot firmware processing by software is executed. First, the processor executes a branch process in S120 to determine whether the reset release is due to user startup or for tool connection. Then, for user startup, to prevent the startup of unauthorized user programs, the process proceeds to S130 to determine whether the execution of secure boot is instructed. In a normal user startup, S130 is determined as YES, and secure boot is executed.

When the execution of secure boot is instructed (S130 is YES), the processor executes the process in S140 after executing the secure boot to determine whether the execution result of the secure boot is "pass" or "fail". If the execution result indicates an abnormal fail (S140 is NO), the process proceeds to S210, and reset processing is executed. In the reset processing, a reset signal instructing a reset is generated for each circuit element mounted on the semiconductor device. As a result, if the execution result of the secure boot is abnormal, a reset is executed for each circuit element, and the user program is not started.

If the execution result of the secure boot indicates a normal "pass" (S140 is YES), the processor does not execute the reset processing (S210). That is, as a secure boot by software processing, the user startup is permitted. Also, when the execution of secure boot is not instructed (S130 is YES), S140 is skipped, so the reset processing (S210) is not executed.

There is concern that S130 or S140 may be misjudged due to a voltage glitch attack that momentarily fluctuates the power supply voltage during user startup. As a result, there is concern that during the startup of an unauthorized user program, the secure boot that should be executed is not instructed (S130 is mistakenly determined as NO), or the secure boot result is mistakenly recognized as pass when it is actually fail (S140 is YES). As a result, there is concern that the secure boot by software processing may be bypassed for the startup of an unauthorized user program, and the reset processing (S210) cannot be executed.

Therefore, in the semiconductor device according to the comparative example, even if the execution result of the secure boot by software processing is normal, security resilience is enhanced by executing the secure boot by hardware processing in S150 and S160.

In S150, it is determined whether the execution of secure boot is instructed based on the data value stored in the first secure F/F targeted by the reset sequence in S110. When the execution of secure boot is instructed (S150 is YES), the secure boot is executed, and the value indicating the execution result (pass/fail) of the secure boot is written to a second secure F/F different from the first secure F/F used in the determination of S150.

In S160, it is determined whether the execution result of the secure boot is pass or fail based on the data value of the second secure F/F. If the execution result of the secure boot is fail, S160 is determined as NO, and reset processing is executed by S220.

Note that in S210 and S220, "S/W reset" and "H/W reset" are used to distinguish whether the reset processing is initiated by software processing or hardware processing, respectively, but the content of the reset processing executed in S210 and S220 is the same, and in S220, a reset signal instructing a reset is generated for each circuit element mounted on the semiconductor device.

Thus, in the glitch countermeasure processing according to the comparative example, even if the secure boot by software processing is breached by a voltage glitch attack, it is expected that executing the secure boot by hardware processing will enhance security resistance.

On the other hand, in hardware processing, if the data value of the first secure F/F, which indicates the result of the secure boot execution, shows a pass (when S160 is judged as YES), the reset processing (S220) is not executed. Also, when the data value of the aforementioned second secure F/F is a value that indicates non-execution of secure boot (when S150 is judged as NO), S160 is skipped, so the reset processing (S210) is not executed. In this way, if the reset processing (S210, S220) is not activated in both software and hardware processing, the process proceeds to S200, and user activation is permitted.

In contrast, the inventors discovered that in the security processing according to the comparative example, there are cases where the data value of the aforementioned first secure F/F or the second secure F/F is rewritten from its original value due to a voltage glitch attack, resulting in S150 being incorrectly judged as NO or S160 being incorrectly judged as YES. That is, it was found as a further issue that there is room for improvement in enhancing security resistance against voltage glitches in the security processing according to the comparative example with added hardware processing. The inventors conceived and embodied the semiconductor device according to the present disclosure to solve this issue.

### Security Processing According to the Present Disclosure

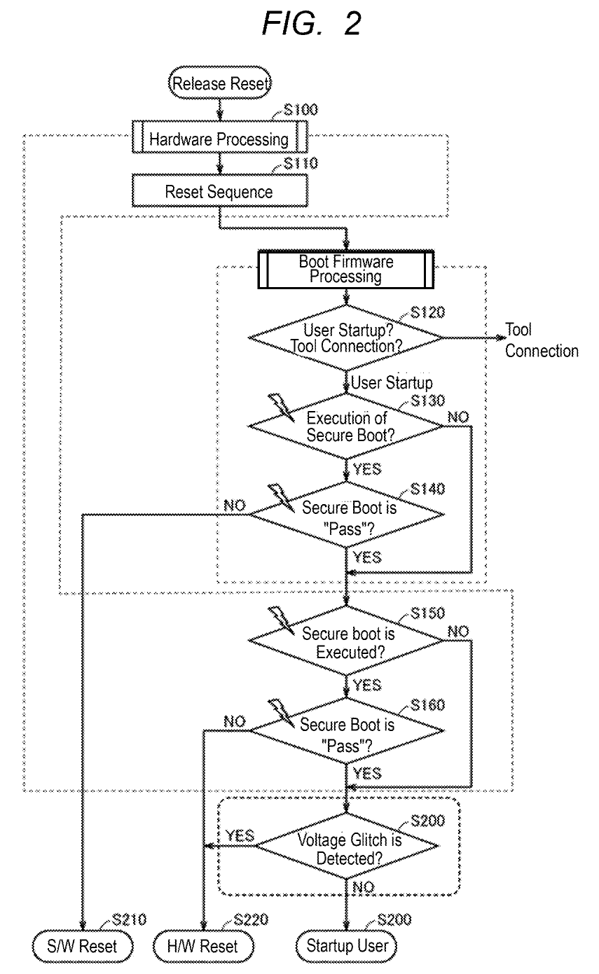

FIG. 2 is a flowchart illustrating the security processing according to the present disclosure.

Referring to FIG. 2, the security processing according to the present embodiment executes voltage glitch detection processing by S200, in addition to the software and hardware processing by S110 to S180 similar to FIG. 1 (comparative example). If a voltage glitch is detected, S200 is judged as YES, and the reset processing by S220 is executed.

On the other hand, if the reset processing is not executed by software and hardware processing (when S160 is judged as YES), and the occurrence of a voltage glitch is not detected, S200 is judged as NO, and user program activation (user activation) is permitted by S200 without executing reset processing.

That is, in the present disclosure, security resistance is enhanced not only by relying on security judgment based on data values that may be affected by voltage glitch attacks but also by performing security judgment directly based on the presence or absence of voltage glitch detection.

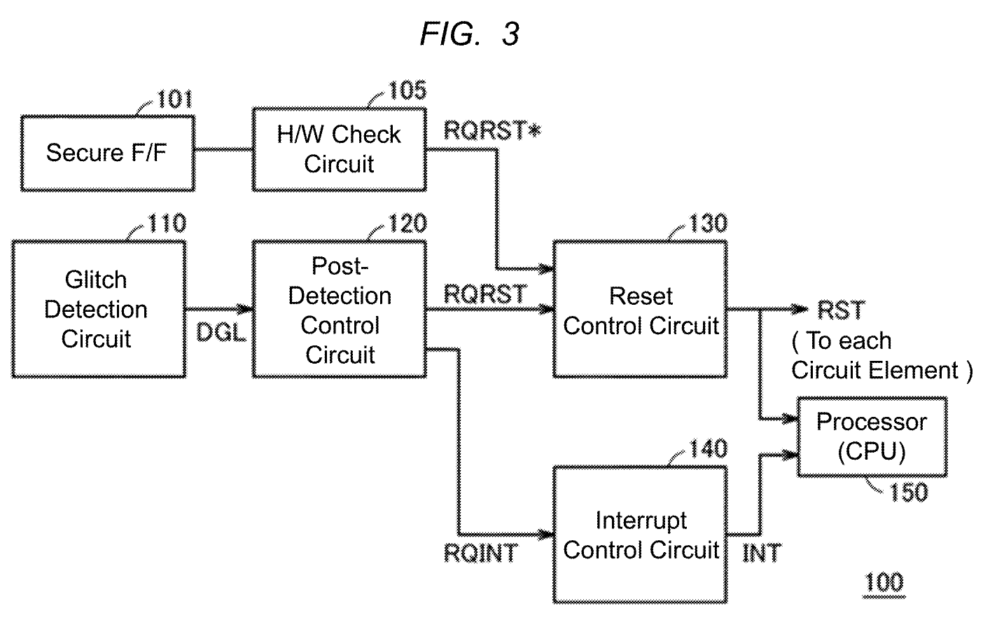

FIG. 3 is a block diagram illustrating the configuration of the main parts for voltage glitch countermeasures of the semiconductor device 100 according to the present disclosure.

As shown in FIG. 3, the semiconductor device 100 includes a secure F/F101, an H/W check circuit 105, a glitch detection circuit 110, a post-detection control circuit 120, a reset control circuit 130, an interrupt control circuit 140, and a processor 150. The semiconductor device 100 executes the security processing shown in FIG. 2 upon reset release.

The secure F/F101 stores data values indicating the enablement or disablement of security functions such as the execution instruction (presence/absence) of secure boot or the execution result (pass/fail) of the secure boot, as described above. That is, the secure F/F101 corresponds to an embodiment of the “data retention circuit” according to the present disclosure.

The H/W check circuit 105 is a hardware element for executing the processing of S110, S150, and S160 in FIG. 2 based on the output data value of the secure F/F101. The H/W check circuit 105 is configured to generate a reset request signal RQRST* when S160 is judged as NO. The H/W check circuit 105 corresponds to an embodiment of the “check circuit” according to the present disclosure.

The glitch detection circuit 110 is configured to output a glitch detection signal DGL when a voltage glitch is detected. That is, the glitch detection circuit 110 is a hardware element for executing the processing of S200 in FIG. 2 and generates the glitch detection signal DGL when S200 is judged as YES.

The post-detection control circuit 120 is configured to output a reset request signal RQRST or an interrupt request signal RQINT when the glitch detection signal DGL is output from the glitch detection circuit 110. At the start of the user program where the security processing shown in FIG. 2 is executed, the post-detection control circuit 120 outputs a reset request signal RQRST to the reset control circuit 130 in response to the glitch detection signal DGL. On the other hand, after the completion of the user program activation, the post-detection control circuit 120 outputs an interrupt request signal RQINT to the interrupt control circuit 140 in response to the glitch detection signal DGL. The post-detection control circuit corresponds to an embodiment of the “control circuit” according to the present disclosure.

The reset control circuit 130 generates a reset signal RST in response to the reset request signal RQRST* from the H/W check circuit 105 or the reset request signal RQRST from the post-detection control circuit 120. The reset signal RST is output to each circuit element including the processor 150. That is, the reset control circuit 130 can output the reset signal RST during the execution of the H/W reset (S220) when S160 is judged as NO or S200 is judged as YES.

The interrupt control circuit 140 outputs an interrupt control signal INT to processor 150 in response to the interrupt request signal RQINT from the post-detection control circuit 120. Processor 150 stops the processing by the normal user program, etc., in response to the interrupt control signal INT and executes the predetermined interrupt processing (second embodiment) at the time of glitch detection.

Moreover, processor 150 is configured to execute the software processing by S120 to S140 in FIG. 2, and during the execution of the S/W reset (S210) when S140 is judged as NO, it executes its own reset operation and instructs the reset operation to each circuit element other than the processor 150 of the semiconductor device 100.

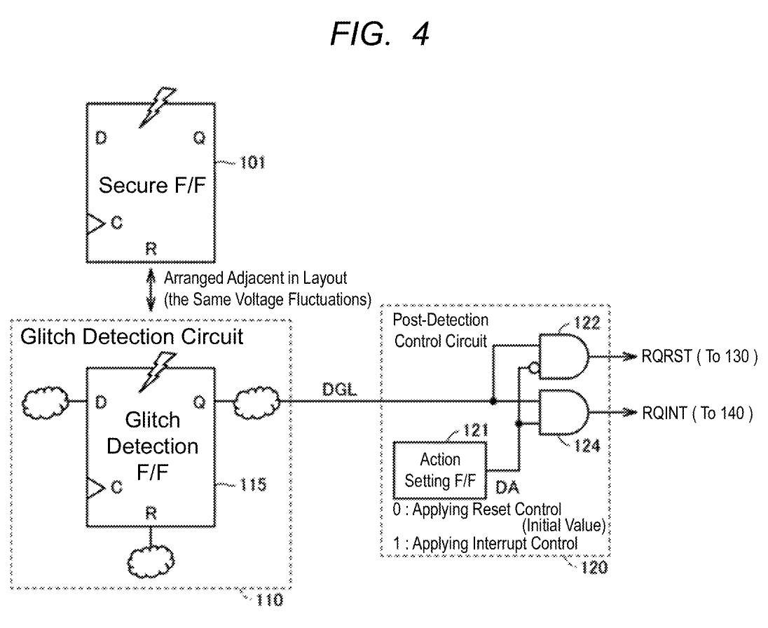

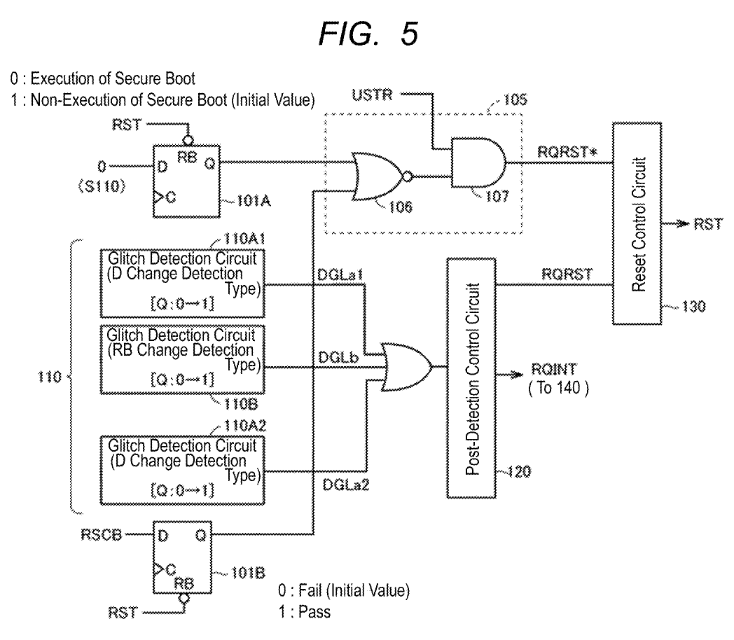

Next, the operation of the glitch detection circuit and the configuration of the post-detection control circuit will be described with reference to FIG. 4. Referring to FIG. 4, the secure F/F101 comprehensively represents the aforementioned first secure F/F and second secure F/F. The first secure F/F is written with a data value instructing the execution of secure boot by the processing of S110 (reset sequence) in FIG. 2. Also, the second secure F/F is written with a data value indicating the execution result (fail/pass) of secure boot, executed when S150 is judged as YES in FIG. 5.

Hereinafter, regarding the data values stored in the secure F/F101, the data value indicating the enablement of the security function is “0”, which is a logical low-level value (GND), and the data value indicating the disablement of the security function is “1”, which is a logical high-level value (VDD). Therefore, the data value instructing the execution of secure boot in S150 is “0”, while the data value indicating non-execution of secure boot in S150 is “1'. Also, regarding the execution result of the security function (secure boot), the data value indicating “fail (abnormal)” is “0”, and the data value indicating “pass (normal)” is “1”.

The glitch detection circuit 110 includes a glitch detection F/F115. The glitch detection F/F115 comprehensively represents the glitch detection F/Fs arranged corresponding to the aforementioned first secure F/F and second secure F/F. The glitch detection F/F115 is arranged in proximity to the secure F/F101 in layout to receive the same voltage fluctuations as the secure F/F101. For example, the glitch detection F/F115 can be arranged adjacent to the glitch detection circuit 110 in layout.

The glitch detection F/F115 is configured such that the output data value (Q) changes from the initial value (e.g., from “0” to “1”) when voltage fluctuations (i.e., voltage glitches) are detected. That is, when the output data value of the glitch detection F/F115 is “1”, the glitch detection circuit 110 is in a state of outputting the glitch detection signal DGL (DGL='1”). Conversely, when the output data value of the glitch detection F/F115 is the initial value “0”, the glitch detection circuit 110 is in a state of not outputting the glitch detection signal DGL (DGL=“0”). That is, the glitch detection F/F115 corresponds to an embodiment of the “voltage fluctuation detection circuit” according to the present embodiment.

The post-detection control circuit 120 includes an action setting F/F121 and logic gates 122, 124. The action setting F/F121 holds a data value DA indicating which of the reset control processing and interrupt control processing to execute when a voltage glitch is detected. Using the data value DA, branching processing in S120 (FIG. 2) can be executed.

For example, when applying reset control that requests reset processing upon detection of a voltage glitch, the action setting F/F121 holds “0”. On the other hand, the action setting F/F121 is supposed to hold “1” when applying interrupt control that requests interrupt processing upon detection of a voltage glitch. It should be noted that the action setting F/F121 holds “0” as an initial value after the reset process (DA=“0”), while after user startup completion, it is written and held as “1” by the user program (DA=“1”).

Logic gate 122 outputs the AND operation result of the inverted logical value of the data value DA from the action setting F/F121 and the logical value of the glitch detection signal DGL as the reset request signal RQRST. The reset request signal RQRST is output to the reset control circuit 130. Additionally, logic gate 122 outputs the AND operation result of the output data value DA of the action setting F/F121 and the glitch detection signal DGL as the interrupt request signal RQINT. The interrupt request signal RQINT is output to the interrupt control circuit 140.

Therefore, when a voltage glitch is not detected (DGL=“0”), logic gates 122 and 124 output “0” (RQRST=RQINT=0), resulting in a state where neither the reset request signal RQRST nor the interrupt request signal RQINT is output.

In contrast, when a voltage glitch is detected (DGL=“1”) and DA=0 (during reset control application), logic gate 122 outputs “1”. Furthermore, since logic gate 124 outputs “0” (RQRST=1, RQINT=0), the reset request signal RQRST is output.

Conversely, when a voltage glitch is detected (DGL=“1”) and DA=1 (during interrupt control application), logic gate 122 outputs “0”. Furthermore, since logic gate 124 outputs “1” (RQRST=0, RQINT=1), the interrupt request signal RQINT is output.

### First Embodiment

In the first embodiment, the circuit configuration of a semiconductor device for security processing during user startup, as explained in FIG. 2, is described. This corresponds to the configuration for realizing the circuit operation of the semiconductor device 100 during the period when the data value held by the action setting F/F121 in FIG. 4 is “0”.

Here, by causing positive or negative pulse fluctuations to the power supply voltage VDD through a voltage glitch attack, the data value held by the F/F (e.g., secure F/F101 in FIG. 4) may change to a data value that disables the security function (e.g., “1”).

For example, by changing the input data value (D) of the F/F, the data value held by the F/F (secure F/F101) may change to a data value that disables the security function. Alternatively, by causing a voltage change in the reset signal, the F/F (secure F/F101) may be set or reset, resulting in the held data value changing to a data value that disables the security function.

Therefore, the glitch detection circuit 110, depending on the combination of the initial value of the secure F/F101 and the definition of the data value (valid/invalid, pass/fail), needs to detect which polarity of data value change in the secure F/F101, i.e., whether it needs to detect a change from “1” to “0” or from “0” to “1”.

FIG. 5 is a block diagram illustrating a configuration example of a semiconductor device according to the first embodiment. Referring to FIG. 5, in the semiconductor device according to the first embodiment, the H/W check circuit 105 includes logic gates 106 and 107 that receive the output data (Q) values of secure F/F101A and 101B.

Secure F/F101A corresponds to the aforementioned “first secure F/F” and is written with a data value indicating the enable/disable status of the security function.

In the first embodiment, secure F/F101A has an initial value of “1” set at the time of reset release, while during the reset sequence at S110 (FIG. 2), a data value that enables the security function (i.e., “0”) is written. That is, in secure F/F101A, an initial value that disables the security function is set.

Secure F/F101B corresponds to the aforementioned “second secure F/F” and is written with a data value indicating the execution result of the security function (secure boot). As mentioned above, for secure F/F101B, “0” is written when the execution result of the security function (secure boot) is “fail”, while “1” is written when it is “pass”.

In the first embodiment, secure F/F101B is assumed to have an initial value of “0” set at the time of reset release. That is, in secure F/F101B, an initial value that enables the security function is set.

Logic gate 106 outputs the NOR (negative OR) operation result of the output data values (Q) of secure F/F101A and 101B. Logic gate 107 outputs the AND operation result of the output value of logic gate 106 and the user startup start signal URST as the reset request signal RQRST* of the H/W check circuit 105. It should be noted that the user startup start signal URST is set to “1” from when S120 in FIG. 2 branches to “user startup” until the user startup is completed and is set to “0” during other periods.

Therefore, from the H/W check circuit 105, when the user startup start signal URST=“0”, RQRST* is fixed to 0, and the reset request signal RQRST* is not output. On the other hand, during the period when the user startup start signal URST=“1”, if the output data value of secure F/F101A is “0 (secure boot execution)” and the output data value of secure F/F101B is “0 (fail)”, RQRST* is set to 1, and the reset request signal RQRST* is output. As a result, the reset process (H/W reset) by S220 in FIG. 2 is executed.

On the other hand, in a state where the H/W reset process should originally be executed, if the input data value (D) in either secure F/F101A or 101B changes from “0” to “1” due to a voltage glitch attack, the output data value (Q) changes from “0” to “1”, preventing the reset process from being executed.

Additionally, the reset signal RST changes due to a voltage glitch attack, causing secure F/F101A and 101B to be reset. As a result, the output data value (Q) is initialized, which may cause the output data value (Q) to change from its original value.

As mentioned above, in secure F/F101B, since an initial value that enables the security function is set, the security function does not degrade even if the reset signal RST changes due to a voltage glitch attack. On the other hand, in secure F/F101A, since an initial value that disables the security function is set, the security function degrades due to changes in the reset signal RST caused by a voltage glitch.

As a result, for secure F/F101A, it is necessary to arrange both glitch detection circuit 110A1, which detects voltage glitches that change the output data value (Q) from “0” to “1” by changing the input data value (D), and glitch detection circuit 110B, which detects voltage glitches that change the output data value (Q) from “0” to “1” by changing the reset signal RST.

On the other hand, for secure F/F101B, it is not necessary to detect voltage glitches that change the reset signal RST, and it is only necessary to arrange glitch detection circuit 110A2, which detects voltage glitches that change the output data value (Q) from “0” to “1” by changing the input data value (D).

Glitch detection circuit 110A1 is arranged in proximity to secure F/F101A. Glitch detection circuit 110A1 is configured to detect voltage glitches that cause a change from “0” to “1” in the input data value (D) for secure F/F101A. Glitch detection circuit 110B is arranged in proximity to secure F/F101A. Glitch detection circuit 110B is configured to detect voltage glitches that cause a change from “1” to “0” (reset initiation) in the reset input value (RB) for secure F/F101A.

Glitch detection circuit 110A2 is arranged in proximity to secure F/F101B. Glitch detection circuit 110A2 is configured to detect voltage glitches that cause a change from “0” to “1” in the input data value (D) for secure F/F101B.

Glitch detection circuits 110A1 and 100A2 have the same function and configuration. Therefore, hereinafter, glitch detection circuits 110A1 and 100A2 are collectively referred to as glitch detection circuit 110A.

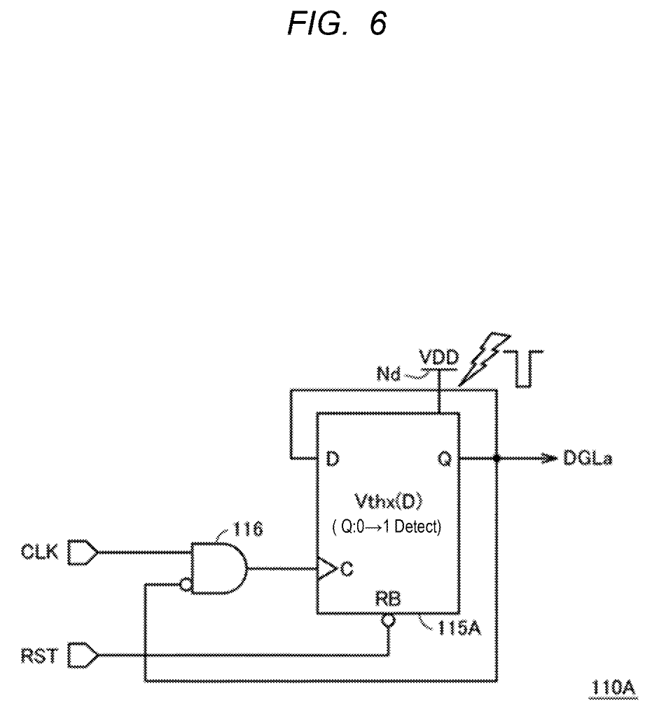

FIG. 6 is a conceptual diagram illustrating a configuration example of glitch detection circuit 110A. Referring to FIG. 6, glitch detection circuit 110A includes a glitch detection flip-flop (hereinafter, glitch detection F/F) 115A and a logic gate 116. Logic gate 116 outputs the AND operation result of the clock signal CLK and the inverted logical value of the output data value (Q).

The glitch detection F/F115A is configured to loop back the output data value (Q) to the input data value (D) and to use the output of logic gate 116 as the clock input value (C). The glitch detection signal DGLa from the glitch detection circuit 110A has the same logical value as the output data value (Q) of the glitch detection F/F115A.

The glitch detection F/F115A is initialized to an output data value (Q) of "0" when the reset signal RST is set to "1" (reset state), causing the reset input value (RB) to become "0" and reset. Due to the loopback connection, the input data value (D) and output data value (Q) are maintained at "0" thereafter.

The glitch detection F/F115A is configured to easily change the output data value (Q) from "0" to "1" in response to the application of a negative glitch to the power supply voltage VDD (power node Nd). Specifically, the glitch detection F/F115A is configured such that the logical threshold voltage Vthx for the input data value (D) is lower than the normal logical threshold voltage Vth (Vth = (VDD/2)). A specific configuration example of such a glitch detection F/F115A will be described later. In the first embodiment, the glitch detection F/F115A corresponds to an example of the "first flip-flop”.

When the output data value (Q) changes to "1" in response to the occurrence of a voltage glitch, the output of logic gate 116 is fixed at "0”, gating the clock of the glitch detection F/F115A. As a result, even if a voltage glitch occurs again, the output data value (Q) in the glitch detection F/F115A remains unchanged at "1" until the next reset.

Therefore, the glitch detection signal DGLa is initialized to "0" after reset release and changes from "0" to "1" when a voltage glitch (negative voltage fluctuation of the power supply voltage VDD) is detected. Thus, the glitch detection F/F115A is in a state to output the glitch detection signal DGLa. The glitch detection signal DGLa is maintained at "0" until a voltage glitch is detected after reset release and is maintained at "1" until the next reset after the voltage glitch is detected. The glitch detection signal DGLa corresponds to a comprehensive representation of the glitch detection signal DGLa1 from the glitch detection circuit 110A1 (FIG. 5) and the glitch detection signal DGLa2 from the glitch detection circuit 110A2 (FIG. 5).

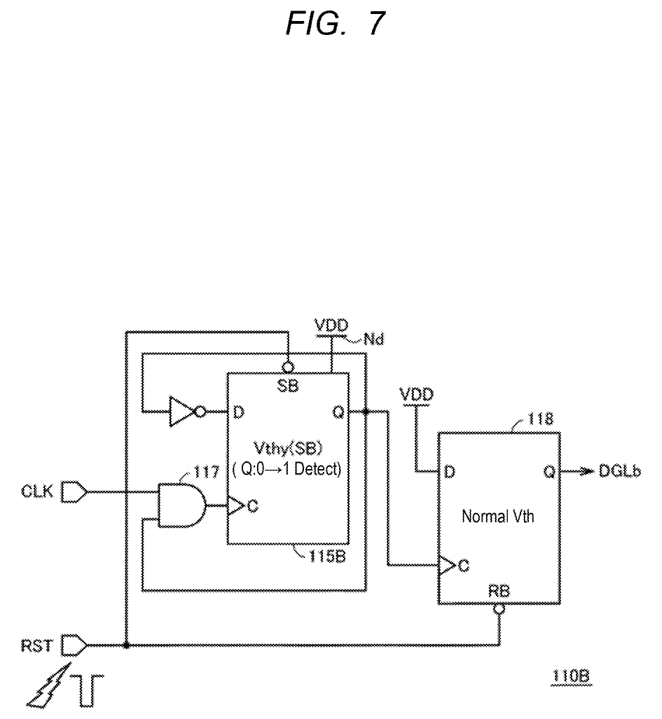

FIG. 7 is a conceptual diagram illustrating a configuration example of the glitch detection circuit 110B. Referring to FIG. 7, the glitch detection circuit 110B includes a glitch detection F/F115B, a logic gate 117, and an output holding flip-flop (hereinafter, holding F/F) 118 for the glitch detection F/F. The logic gate 117 outputs the AND (logical product) operation result of the clock signal CLK and the output data value (Q).

The glitch detection F/F115B is configured to invert the output data value (Q) with an inverter and loop back to the input data value (D), and to use the output of logic gate 116 as the clock input value (C).

The holding F/F118 is configured such that the D terminal is connected to the power node Nd (power supply voltage VDD), fixing the input data value (D) at "1”, and receives the output data value (Q) of the glitch detection F/F115B as the clock input value (C). The glitch detection signal DGLb from the glitch detection circuit 110B has the same logical value as the output data value (Q) of the holding F/F118.

When the reset signal RST is set to "1" (reset state), the glitch detection F/F115B is initialized to an output data value (Q) of "1" by setting the set input value (SB) to "0”, but due to the loopback connection with inversion, the input data value (D) and output data value (Q) are set to "0”.

When the output data value (Q) becomes "0”, the output of logic gate 116 is fixed at "0”, gating the clock of the glitch detection F/F115B, thereby maintaining the output data value (Q) at "0”.

When the reset signal RST is set to "1”, the holding F/F118 is initialized to hold "0”, so the output data value (Q) and glitch detection signal DGLb are initialized to "0”. As described above, after reset release, the output data value (Q) of the glitch detection F/F115B, which is the clock input value (C), is maintained at "0”, so the output data value (Q) of the holding F/F118 and the glitch detection signal DGLb are maintained at "0”.

The glitch detection F/F115B is configured such that the logical threshold voltage Vthy for the set input value (SB) is higher than the normal logical threshold voltage Vth (Vth = (VDD/2)), making it easier for the output data value (Q) to change from "0" to "1" when a negative voltage fluctuation occurs in the reset signal RST. A specific configuration example of such a glitch detection F/F115B will be described later. On the other hand, the holding F/F118 is composed of a normal flip-flop with a normal logical threshold voltage Vth. In the first embodiment, the glitch detection F/F115B corresponds to an example of the "second flip-flop”.

When the output data value (Q) of the glitch detection F/F115B changes to "1”, the holding F/F118 captures the input data value (D), which is fixed at the power supply voltage VDD (i.e., "1"), as the clock input value (C) changes to "1”. As a result, the output data value (Q) of the holding F/F118 and the glitch detection signal DGLb change from "0" to "1”. Thus, the glitch detection F/F115B is in a state to output the glitch detection signal DGLb. In the glitch detection F/F115B, since the input data value (D) is fixed at "1”, the output data value (Q) remains unchanged at "1" until the next reset.

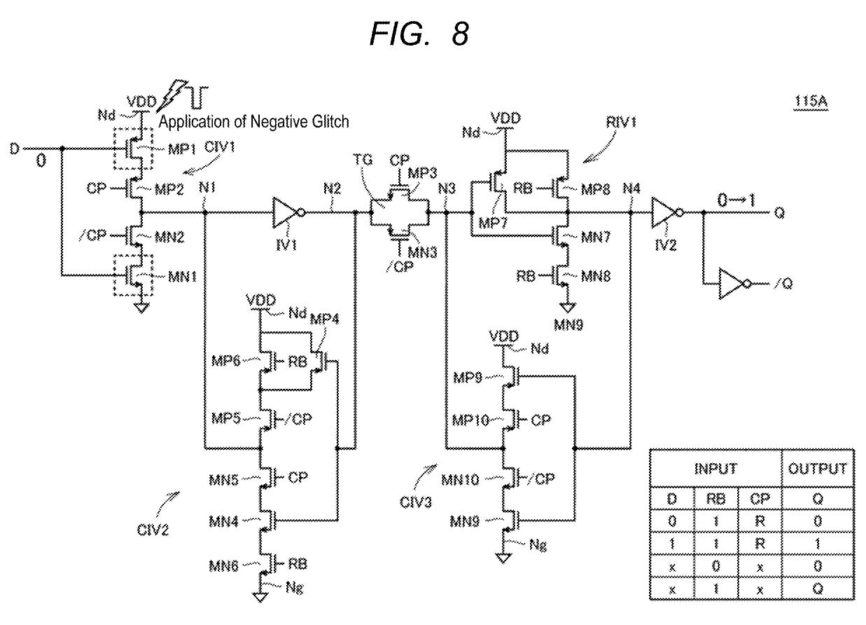

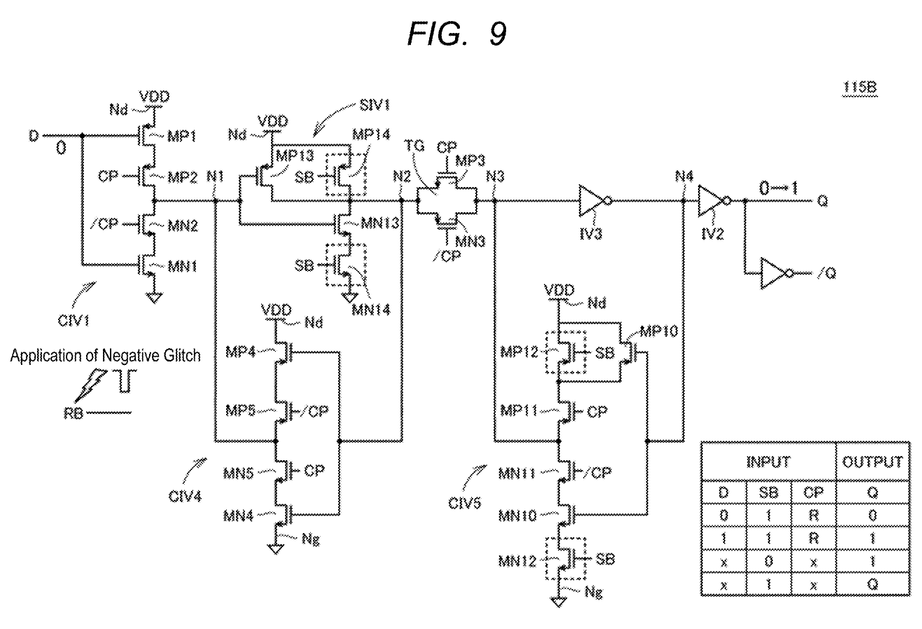

Next, specific configuration examples of the glitch detection F/F shown in FIGS. 6 and 7 will be described with reference to FIGS. 8 and 9. First, the glitch detection F/F115A for detecting the change of the input data value (D) from "0" to "1" due to a negative voltage glitch in the power supply voltage VDD will be described.

FIG. 8 is a circuit diagram illustrating a configuration example of the glitch detection F/F115A shown in FIG. 6.

Referring to FIG. 8, the glitch detection F/F115A includes a first stage clocked inverter CIV1 receiving the input data value (D), an inverter IV1, and a clocked inverter CIV2 with a reset function. In addition, the glitch detection F/F115D further includes a transfer gate TG, an inverter RIV1 with a reset function, a clocked inverter CIV3, and an inverter IV2.

The clocked inverter CIV1 includes P-type transistors MP1, MP2 and N-type transistors MN1, MN2. The P-type transistor MP1 has a source connected to the power node Nd (power supply voltage VDD) and receives the input data value (D) at its gate. The N-type transistor MN1 has a source connected to the GND node Ng and receives the input data value (D) at its gate.

The P-type transistor MP2 is connected between the P-type transistor MP1 and node N1 and receives the clock input value (CP) at its gate. The N-type transistor MN2 is connected between the N-type transistor MN1 and node N1 and receives the inverted logical value of the clock input value (/CP) at its gate.

Therefore, the clocked inverter CIV1 operates to output the inverted logical value of the input data value (D) to node N1 when the clock input value (CP) is "0”. The inverter IV1 inverts the signal of node N1 and outputs it to node N2.

The clocked inverter CIV2 with a reset function includes P-type transistors MP4 to MP6 and N-type transistors MN4 to MN6. The P-type transistor MP4 and N-type transistor MN4 form an inverter by having gates connected to node N2. The gates of the N-type transistor MN5 and P-type transistor MP5 receive the clock input value (CP) and its inverted logical value (/CP), respectively.

The gates of the N-type transistor MN6 and P-type transistor MP6 receive the reset input value (RB). The N-type transistor MN6 has a source connected to the GND node Ng. The P-type transistor MP6 has a source connected to the power node Nd.

The N-type transistors MN4 to MN6 are connected in series between node N1 and the GND node Ng. The P-type transistors MP6 and MP5 are connected in series between the power node Nd and node N1, and the P-type transistor MP4 is connected in parallel with the P-type transistor MP6.

The clocked inverter CIV2 operates to output the inverted logical value of the signal of node N2 to node N1 when the reset input value (RB) is "1" and the clock input value (CP) is "1”. On the other hand, during the period when the reset input value (RB) is "0”, the operation as an inverter is stopped by turning on the P-type transistor MP6 and turning off the N-type transistor MN6. Therefore, during the period when the reset input value (RB) is “1”, a latch circuit can be configured using the clocked inverter CIV2 and inverter IV1.

The transfer gate TG has a P-type transistor MP3 and an N-type transistor MN3 connected in parallel between nodes N2 and N3. The gates of the P-type transistor MP3 and N-type transistor MN3 receive the clock input value (CP) and its inverted logic value (/CP), respectively. The transfer gate TG operates to transmit the signal from node N2 to node N3 during the period when the clock input value (CP) is “0”. On the other hand, During the period when the clock input value (CP) is “1”, nodes N2 and N3 are disconnected.

The inverter RIV1 with reset function has P-type transistors MP7, MP8 and N-type transistors MN7, MN8. The P-type transistor MP7 and N-type transistor MN7 form an inverter by having gates connected to node N3.

The gates of the N-type transistor MN8 and P-type transistor MP8 receive the reset input value (RB). The N-type transistor MN8 has a source connected to the GND node Ng. The P-type transistor MP8 has a source connected to the power node Nd.

The N-type transistors MN7 and MN8 are connected in series between node N4 and the GND node Ng. The P-type transistors MP7 and MP8 are connected in parallel between the power node Nd and node N4. Therefore, the inverter RIV1 operates to output the inverted logic value of the signal at node N3 to node N4 during the period when the reset input value (RB) is “1”.

On the other hand, during the period when the reset input value (RB) is “0”, the operation as an inverter is stopped by turning on the P-type transistor MP8 and turning off the N-type transistor MN8, and node N4 is fixed to “1”.

The clocked inverter CIV3 has P-type transistors MP9, MP10 and N-type transistors MN9, MN10. The P-type transistors MP9 and MP10 are connected in series between the power node Nd (power supply voltage VDD) and node N3. The N-type transistors MN9, MN10 are connected in series between node N3 and the GND node Ng. The P-type transistor MP9 and N-type transistor MN9 form an inverter by having gates connected to node N4. The gates of the P-type transistor MP10 and N-type transistor MN10 receive the clock input value (CP) and its inverted logic value (/CP), respectively.

The clocked inverter CIV3 operates to output the inverted logic value of the signal at node N4 to node N3 when the clock input value (CB) is “0”. Therefore, during the period when the reset input value (RB) is “1”, a latch circuit can be configured using the inverter RIV1 and clocked inverter CIV3.

The inverter IV2 outputs the inverted logic value of the signal at node N4 as the output data value (Q) of the glitch detection F/F115A. Furthermore, the inverted logic value of the output from inverter IV2 is considered as the inverted logic value (/Q) of the output data value.

Therefore, during the period when the reset signal RST corresponds to “1”, which is when the reset input value (RB) is “0”, the P-type transistor MP8 is fixed to on, setting the output data value (Q) to “0” as the initial value.

On the other hand, during the period when the reset signal RST is “0” (reset input value (RB) is “1”), the glitch detection F/F115A captures the input data value (D) at the rising edge (R) when the clock input value (CB) changes from “0” to “1”. Then, the glitch detection F/F115A operates to transfer to the output data value (Q) during the next “0” period of the clock input value (CB). The output data value (Q) is maintained except at the rising edge (R) of the clock input value (CB). In this way, the glitch detection F/F115A can operate as a normal D flip-flop with a reset function (initial value “0”) that synchronizes with the clock signal CLK (CB).

In the glitch detection F/F115A, the transistor sizes of the P-type transistor MP1 and N-type transistor MN1, which receive the input data value (D) at the gate, specifically the ratio of gate width to gate length (W/L), are adjusted as indicated by the dotted lines in the diagram. As a result, the glitch detection F/F115A is configured to have a logic threshold voltage Vthx (Vthx < (VDD/2)) adjusted for the input data value (D).

In a normal inverter, the transistor sizes (W/L) of the P-type and N-type transistors are designed equally, setting the inverter's logic threshold voltage Vth = (VDD/2). In contrast, for the glitch detection F/F115A, the transistor size of the N-type transistor MN1 is designed to be larger than that of the P-type transistor MP1 in the first stage inverter receiving the input data value (D). This allows the logic threshold voltage Vthx of the first stage inverter to be lower than the logic threshold voltage Vth of a normal inverter.

As a result, the glitch detection F/F115A can be designed so that when a negative voltage fluctuation occurs in the power supply voltage VDD, the inversion from “0 (initial value)” to “1” (i.e., data corruption) easily occurs in the output data value (Q). By placing the glitch detection F/F115A in close proximity to the secure F/F101A or 101B, it is possible to detect the negative-direction glitch in the power supply voltage VDD in the secure F/F101A or 101B with high sensitivity. That is, it is possible to detect with high sensitivity the negative-direction glitch in the power supply voltage VDD that acts to change the input data value (D) from “0” to “1”.

Next, the glitch detection F/F115B for detecting the negative-direction voltage glitch of the reset signal RST will be explained.

FIG. 9 is a circuit diagram illustrating a configuration example of the glitch detection F/F115B shown in FIG. 7.

Referring to FIG. 9, the glitch detection F/F115B includes a first stage clocked inverter CIV1 receiving the input data value (D), an inverter SIV1 with a set function, and a clocked inverter CIV4. In addition, the glitch detection F/F115B further includes a transfer gate TG, normal inverters IV2, IV3, and a clocked inverter CIV5 with a set function.

The clocked inverter CIV1 has P-type transistors MP1, MP2 and N-type transistors MN1, MN2 connected similarly to FIG. 8. Therefore, the clocked inverter CIV1 operates to output the inverted logic value of the input data value (D) to node N1 when the clock input value (CP) is “0”.

The inverter SIV1 with a set function has P-type transistors MP13, MP14 and N-type transistors MN13, MN14. The P-type transistor MP13 and N-type transistor MN13 form an inverter by having gates connected to node N1.

The gates of the N-type transistor MN14 and P-type transistor MP14 receive the set input value (SB). The N-type transistor MN14 has a source connected to the GND node Ng. The P-type transistor MP14 has a source connected to the power node Nd.

The N-type transistors MN13 and MN14 are connected in series between node N2 and the GND node Ng. The P-type transistors MP13 and MP14 are connected in parallel between the power node Nd and node N2. Therefore, the inverter SIV1 operates to output the inverted logic value of the signal at node N1 to node N2 during the period when the set input value (SB) is “1”.

On the other hand, during the period when the set input value (SB) is “0”, the operation as an inverter is stopped by turning on the P-type transistor MP14 and turning off the N-type transistor MN14, and node N2 is fixed to “1”.

The clocked inverter CIV4 is configured as a normal clocked inverter with the P-type transistor MP6 and N-type transistor MN6 removed from the clocked inverter CIV2 (with reset function) in FIG. 8. Therefore, the clocked inverter CIV2 outputs the inverted logic value of the signal at node N2 to node N1 when the clock input value (CP) is “1”. Therefore, during the period when the set input value (SB) is “1”, a latch circuit can be configured using the clocked inverter CIV4 and inverter SIV1.

The transfer gate TG has P-type transistor MP3 and N-type transistor MN3 connected similarly to FIG. 8. The transfer gate TG operates to transmit the signal from node N2 to node N3 during the period when the clock input value (CP) is “0”, while disconnecting nodes N2 and N3 during the period when the clock input value (CP) is “1”. The inverter IV3 outputs the inverted logical value of the signal at node N3 to node N4.

The clocked inverter CIV5 with a set function includes P-type transistors MP10 to MP12 and N-type transistors MN10 to MN12. The P-type transistor MP10 and the N-type transistor MN10 form an inverter by having gates connected to node N4. The gates of the N-type transistor MN11 and the P-type transistor MP11 receive the clock input value (CP) and its inverted logical value (/CP), respectively.

The gates of the N-type transistor MN12 and the P-type transistor MP12 receive the set input value (SB). The N-type transistor MN12 has a source connected to the GND node Ng. The P-type transistor MP12 has a source connected to the power supply node Nd.

The N-type transistors MN10 to MN12 are connected in series between node N3 and the GND node Ng. The P-type transistors MP11 and MP12 are connected in series between the power supply node Nd and node N3, and the P-type transistor MP10 is connected in parallel with the P-type transistor MP12.

The clocked inverter CIV5 operates to output the inverted logical value of the signal at node N4 to node N3 when the set input value (SB) is “1” and the clock input value (CP) is “0”. On the other hand, during the period when the reset input value (RB) is “0”, the P-type transistor MP12 is turned on and the N-type transistor MN12 is turned off, stopping the operation as an inverter. Therefore, during the period when the set input value (SB) is “1”, a latch circuit can be configured by the clocked inverter CIV5 and the inverter IV3.

The inverter IV2, similar to FIG. 8, outputs the inverted logical value of the signal at node N4 as the output data value (Q) of the glitch detection F/F115B. Furthermore, the inverted logical value of the output of the inverter IV2 is set as the inverted logical value (/Q) of the output data value.

Therefore, the glitch detection F/F115B, during the period corresponding to when the reset signal RST is “1” and the set input value (SB) is “0”, has the P-type transistor MP14 fixed on, setting the output data value (Q) to the initial value of “1”.

On the other hand, during the period when the reset signal RST is “0” (set input value (SB) is “1”), the glitch detection F/F115B captures the input data value (D) at the rising edge (R) when the clock input value (CB) changes from “0” to “1”, and operates to transfer it to the output data value (Q) during the “0” period of the next clock input value (CB). The output data value (Q) is maintained except at the rising edge (R) of the clock input value (CB). In this way, the glitch detection F/F115B can operate as a normal D flip-flop with a set function (initial value “1”) that synchronizes with the clock signal CLK (CB).

On the other hand, the glitch detection F/F115B adjusts the transistor size (W/L) between the pair of P-type and N-type transistors, which are enclosed by dotted lines in the figure, with the set input value (SB) input to the gate. For example, the transistor sizes (W/L) of the pair of P-type transistor MP12 and N-type transistor MN12, as well as the pair of P-type transistor MP14 and N-type transistor MN14, are adjusted.

Specifically, in each of these pairs, the transistor size of the P-type transistors MP12, MP14 is designed to be larger than that of the N-type transistors MN12, MN14. This allows the logical threshold voltage Vthy for the set input value (SB) to be higher than the logical threshold voltage Vth (VDD/2) of a normal inverter.

This design of the glitch detection F/F115B makes it easier to initialize when the set input value (SB) changes from “1” to “0” in response to a negative voltage glitch of the reset signal RST. As explained in FIG. 7, when the glitch detection F/F115B is initialized (data value “1”), the clock input value (C) of the holding F/F118 becomes “1”. As a result, the glitch detection signal DGLb, which is the output data value (Q) of the holding F/F118, also changes from “0” to “1”.

As a result, by placing the glitch detection F/F115B in close proximity to the secure F/F101B, it is possible to detect the negative glitch of the reset signal RST in the secure F/F101B with high sensitivity.

Referring again to FIG. 5, the glitch detection circuit 110 outputs the logical OR operation result of the glitch detection signals DGLa1, DGLa2, and DGLb as the glitch detection signal DGL in FIG. 3 to the post-detection control circuit 120.

In the security processing during user activation targeted by the first embodiment, the action setting F/F121 (FIG. 4) outputs “0”. Therefore, the post-detection control circuit 120 sets the reset request signal RQRST to “1” in response to the glitch detection signal DGL being set to “1”. As a result, the reset request signal RQRST is output from the post-detection control circuit 120 to the reset control circuit 130.

The reset control circuit 130, as explained in FIG. 3, sets the reset signal RST to “1” when either the reset request signal RQRST* from the H/W check circuit 105 or the reset request signal RQRST from the post-detection control circuit 120 is set to “1”. As a result, the reset signal RST is output to each circuit element of the semiconductor device 100, making it possible to perform the process of S200 in FIG. 2, that is, to detect the voltage glitch itself and execute the reset process.

In this way, in the semiconductor device according to the first embodiment, during the startup process of the user program, if a voltage fluctuation (voltage glitch) of the power supply voltage VDD or the reset signal RST is detected, the reset process can be executed. In particular, in the configuration described in the first embodiment, it is possible to detect with high sensitivity a voltage glitch that changes the output data value (Q) of the secure F/F101 (101A, 101B) from “0” to “1”. This enhances the security resistance against voltage glitches during user activation.

### Alternative Embodiment

Next, as a modified example of the first embodiment, a configuration to accommodate cases where the initial value setting of the secure F/F101 differs will be described.

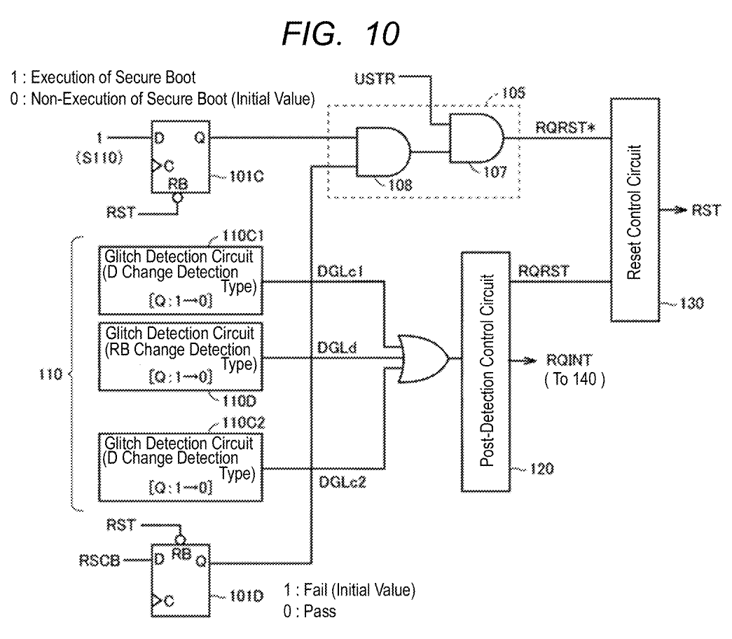

FIG. 10 is a block diagram illustrating a configuration example of a semiconductor device according to a modified example of the first embodiment.

Referring to FIG. 10, the semiconductor device according to the modified example of the first embodiment includes an H/W check circuit 105, secure F/F101C and 101D, and logic gates 107, 108.

The secure F/F101C, similar to the secure F/F101A (FIG. 5), is written with a data value indicating the execution/non-execution of secure boot but differs from the secure F/F101A in that the initial value set upon reset release is “0”, which disables the security function (non-execution of secure boot). Therefore, for the secure F/F101C, a data value (“1”) that enables the security function is written during the reset sequence at S110 (FIG. 2).

The secure F/F101D, similar to the secure F/F101B (FIG. 5), is written with a data value indicating the execution result of the security function (secure boot) but differs from the secure F/F101B in that the initial value set upon reset release is “1”. For the secure F/F101D, “1” is written when the execution result of the security function (secure boot) is “fail”, while “0” is written when it is “pass”. That is, the secure F/F101D, like the secure F/F101B, has an initial value set to enable the security function.

The logic gate 108 outputs the AND operation result of the output data values (Q) of the secure F/F101C and 101D. The logic gate 107 outputs the AND operation result of the output value of the logic gate 108 and the user activation start signal URST, similar to FIG. 5, as the reset request signal RQRST* of the H/W check circuit 105.

Therefore, from the H/W check circuit 105, during the period when the user activation start signal URST=“1”, if the output data value of the secure F/F101C is “1 (security function enabled)” and the output data value of the secure F/F101B is “1 (fail)”, RQRST* is set to “1”, and the reset request signal RQRST* is output. As a result, the reset process (H/W reset) by S220 in FIG. 2 is executed.

In the modified example of the first embodiment, in a state where the H/W reset process should originally be executed, if a voltage glitch attack causes the input data value (D) in either secure F/F101C or 101D to change from “1” to “0”, the output data value (Q) changes from “1” to “0”, preventing the reset process from being executed.

Additionally, if the reset signal RST changes due to a voltage glitch, causing the secure F/F101C and 101D to reset, as explained in the first embodiment, there is a concern that the security function may be compromised in secure F/F101C, where an initial value that disables the security function is set, by the initialization of the output data value (Q).

From the above, in a modified example of the first embodiment, it is necessary to arrange both the glitch detection circuit 110C1 and the glitch detection circuit 110D for secure F/F101C. The glitch detection circuit 110C1 detects a voltage glitch that causes the output data value (Q) to change from “1” to “0” by causing a change in the input data value (D). The glitch detection circuit 110D detects a voltage glitch that changes the output data value (Q) from “1” to “0” by altering the reset signal RST.

On the other hand, for secure F/F101D, it is not necessary to detect a voltage glitch that changes the reset signal RST. Therefore, it is only necessary to arrange the glitch detection circuit 110C2 to detect a voltage glitch that changes the output data value (Q) from “1” to “0” by causing a change in the input data value (D).

The glitch detection circuit 110C1 is arranged in proximity to secure F/F101C. The glitch detection circuit 110C1 is configured to detect a voltage glitch that causes a change from “1” to “0” in the input data value (D) for secure F/F101C. The glitch detection circuit 110D is arranged in proximity to secure F/F101C. The glitch detection circuit 110D is configured to detect a voltage glitch that causes a change from “1” to “0” (reset activation) in the reset input value (RB) for secure F/F101C.

The glitch detection circuit 110C2 is arranged in proximity to secure F/F101D. The glitch detection circuit 110C2 is configured to detect a voltage glitch that causes a change from “0” to “1” in the input data value (D) for secure F/F101D.

Since the glitch detection circuits 110C1 and 110C2 have the same function and configuration, they are collectively referred to as glitch detection circuit 110C hereafter.

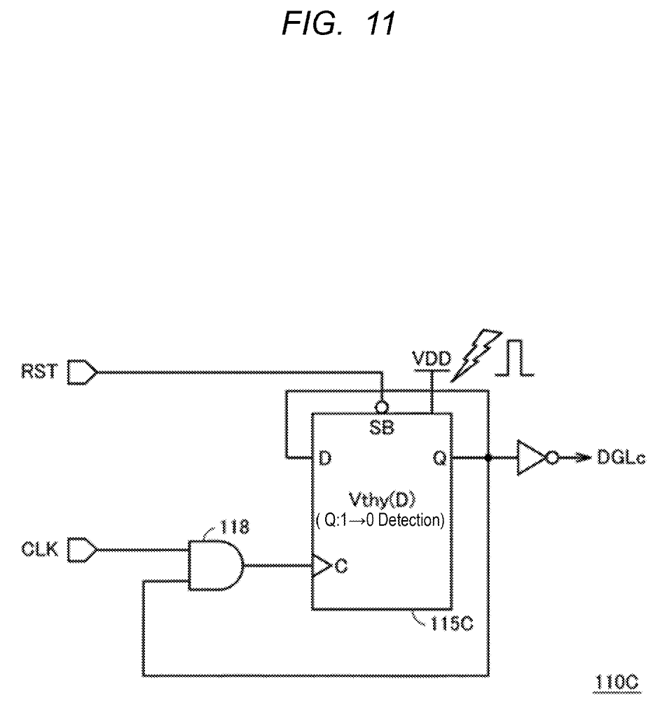

FIG. 11 is a conceptual diagram illustrating a configuration example of the glitch detection circuit 110C. Referring to FIG. 11, the glitch detection circuit 110C includes a glitch detection F/F115C and a logic gate 118. The logic gate 118 outputs the AND (logical product) operation result of the clock signal CLK and the output data value (Q).

The glitch detection F/F115C is configured to loop back the output data value (Q) to the input data value (D) and to use the output of the logic gate 118 as the clock input value (C). The glitch detection signal DGLc from the glitch detection circuit 110C has the inverted logical value of the output data value (Q) of the glitch detection F/F115C.

When the reset signal RST is set to “1” (reset state), the glitch detection F/F115C is set with the set input value (SB) becoming “0”, initializing the output data value (Q) to “1”. Due to the loopback connection, the input data value (D) and the output data value (Q) are maintained at “1” thereafter, so the glitch detection signal DGLc is maintained at “0”.

The glitch detection F/F115C is configured such that the logical threshold voltage Vthy for the input data value (D) is higher than the normal logical threshold voltage Vth (Vth=(VDD/2)), making it easier for the output data value (Q) to change from “1” to “0” in response to a positive glitch applied to the power supply voltage VDD of the power node Nd. A specific configuration example of such a glitch detection F/F115C will be explained later. In a modified example of the first embodiment, the glitch detection F/F115C corresponds to an example of the “first flip-flop”.

When the output data value (Q) changes to “0”, the output of the logic gate 118 is fixed at “0”, so the clock of the glitch detection F/F115C is gated, and even if a voltage glitch occurs again, the output data value (Q) does not change and is maintained at “0” until the next reset.

Therefore, the glitch detection signal DGLc, which has the inverted logical value of the output data value (Q), is initialized to “0” after the reset is released. Subsequently, when a voltage glitch (positive voltage fluctuation of the power supply voltage VDD) is detected, the glitch detection signal DGLc changes from “0” to “1”. As a result, the glitch detection F/F115C is in a state of outputting the glitch detection signal DGLc.

The glitch detection signal DGLc is maintained at “0” until a voltage glitch is detected after the reset is released and is maintained at “1” until the next reset after the voltage glitch is detected. It should be noted that the glitch detection signal DGLc corresponds to a comprehensive notation of the glitch detection signal DGLc1 from the glitch detection circuit 110C1 (FIG. 10) and the glitch detection signal DGLc2 from the glitch detection circuit 110C2 (FIG. 10).

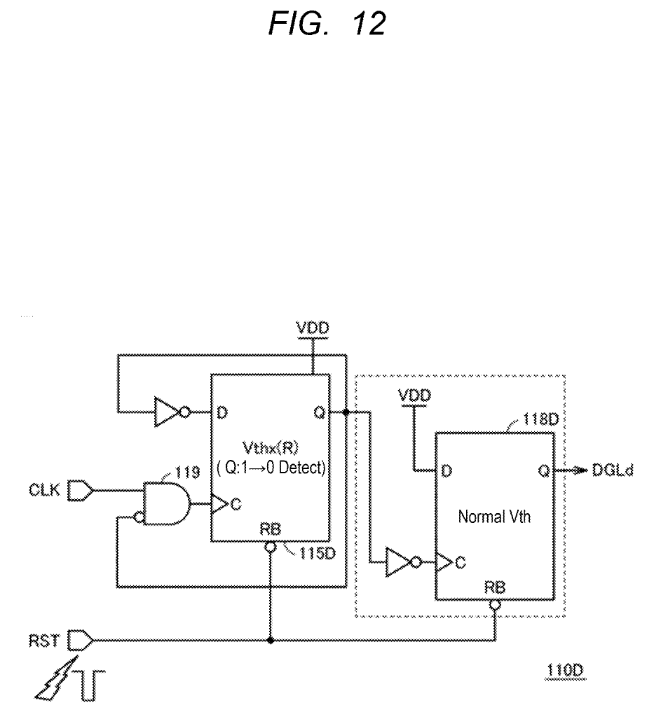

FIG. 12 is a conceptual diagram illustrating a configuration example of the glitch detection circuit 110D. Referring to FIG. 12, the glitch detection circuit 110D includes a glitch detection F/F115D, a logic gate 119, and a holding F/F118D. The logic gate 119 outputs the AND (logical product) operation result of the clock signal CLK and the inverted logical value of the output data value (Q).

The glitch detection F/F115D is configured to invert the output data value (Q) with an inverter and loop back to the input data value (D), and to use the output of the logic gate 119 as the clock input value (C).

The holding F/F118D is configured such that the D terminal is connected to the power node Nd (power supply voltage VDD) and receives the inverted logical value of the output data value (Q) of the glitch detection F/F115D as the clock input value (C). The glitch detection signal DGLd from the glitch detection circuit 110D has the same logical value as the output data value (Q) of the holding F/F118D.

When the reset signal RST is set to “1” (reset state), the glitch detection F/F115D is set with the reset input value (RB) becoming “0”, initializing the output data value (Q) to “0”, but due to the loopback connection with inversion, the input data value (D) and the output data value (Q) are set to “1”.

When the output data value (Q) becomes “1”, the output of the logic gate 116 is fixed at “0”, so the clock of the glitch detection F/F115D is gated, maintaining the output data value (Q) at “1”.

When the reset signal RST is set to “1” (reset state), the holding F/F118D is initialized to hold “0”, so the output data value (Q) and the glitch detection signal DGLb are initialized to “0”. As described above, after the reset is released, the inverted logical value of the output data value (Q) of the glitch detection F/F115D, which is the clock input value (C), is maintained at “0”, so the output data value (Q) of the holding F/F118D and the glitch detection signal DGLd are maintained at “0”.

The glitch detection F/F115D is configured such that the logical threshold voltage Vthy for the reset input value (RB) is higher than the normal logical threshold voltage Vth (Vth=(VDD/2)), making it easier for the output data value (Q) to change from “1” to “0” when a negative voltage fluctuation occurs in the reset signal RST. A specific configuration example of such a glitch detection F/F115D will be explained later. On the other hand, the holding F/F118D is configured as a flip-flop with a normal logical threshold voltage Vth, similar to the holding F/F in FIG. 6. In a modified example of the first embodiment, the glitch detection F/F115D corresponds to an example of the “second flip-flop”.

When the output data value (Q) of the glitch detection F/F115D changes from “1” to “0”, the clock input value (C) of the holding F/F118D changes to “1”, causing the input data value (D), which is fixed at the power supply voltage VDD (i.e., “1”), to be captured. As a result, the output data value (Q) of the holding F/F118 and the glitch detection signal DGLd change from “0” to “1”. As a result, the glitch detection F/F115D is in a state of outputting the glitch detection signal DGLd. In the glitch detection F/F115D, since the input data value (D) is fixed at “1”, the output data value (Q) is maintained at “1” without change until the next reset.

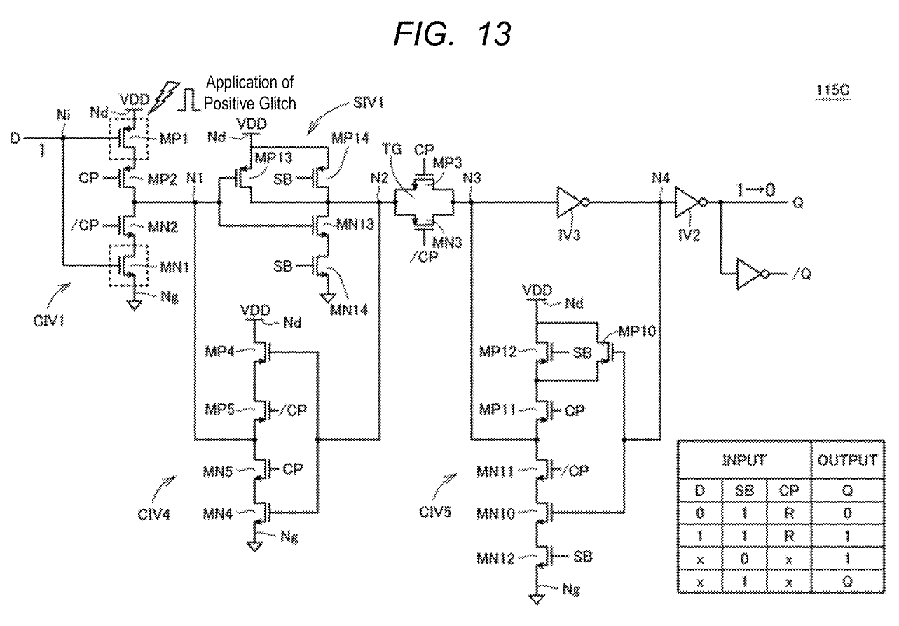

Next, a specific configuration example of the glitch detection F/F shown in FIG. 10 and FIG. 11 will be explained with reference to FIG. 12 and FIG. 13. First, the glitch detection F/F115C for detecting a change from “1” to “0” in the input data value (D) due to a positive voltage glitch in the power supply voltage VDD will be explained.

FIG. 13 is a circuit diagram illustrating a configuration example of the glitch detection F/F115C shown in FIG. 11.

Referring to FIG. 13, the glitch detection F/F115C has a configuration similar to the glitch detection F/F115B in FIG. 9. Namely, the glitch detection F/F115C includes a first stage clocked inverter CIV1 that receives the input data value (D), an inverter SIV1 with a set function, and a clocked inverter CIV4. In addition, the glitch detection F/F115C further includes a transfer gate TG, standard inverters IV2 and IV3, and a clocked inverter CIV5 with a set function. The operation of each element of the glitch detection F/F115C with respect to the clock input value (CP) and the set input value (SB) is the same as that of the glitch detection F/F115B, so a detailed explanation will not be repeated.

Therefore, during the period when the reset signal RST is “1”, corresponding to the period when the set input value (SB) is “0”, the P-type transistor MP14 is fixed to on, setting the output data value (Q) to “1” as the initial value.

On the other hand, during the period when the reset signal RST is “0” (set input value (SB) is “1”), the glitch detection F/F115B operates to capture the input data value (D) at the rising edge (R) where the clock input value (CB) changes from “0” to “1”, and transfers it to the output data value (Q) during the “0” period of the next clock input value (CB). The output data value (Q) is maintained except at the rising edge (R) of the clock input value (CB).

The glitch detection F/F115C is configured to have an adjusted logic threshold voltage Vthy (Vthy > (VDD/2)) for the input data value (D) by adjusting the transistor sizes of the P-type transistor MP1 and N-type transistor MN1, which are input to the gate, specifically the ratio of gate width to gate length (W/L), as enclosed by the dotted line in the figure.

Specifically, by designing the transistor size of the P-type transistor MP1 to be larger than that of the N-type transistor MN1, the logic threshold voltage Vthx of the first stage inverter receiving the input data value (D) can be made higher than the logic threshold voltage Vth (VDD/2) of a standard inverter.

This allows the glitch detection F/F115C to be designed so that when a positive voltage fluctuation occurs in the power supply voltage VDD, an inversion from the initial value “1” to “0” (i.e., data corruption) is likely to occur in the output data value (Q). As a result, by placing the glitch detection F/F115C in proximity to the secure F/F101C or 101D, it is possible to detect the positive direction glitch in the power supply voltage VDD in the secure F/F101C or 101D with high sensitivity. This enables the detection of voltage glitches that act to change the input data value (D) from “1” to “0” with high sensitivity.

Next, the glitch detection F/F115D for detecting negative voltage glitches of the reset signal RST will be described.

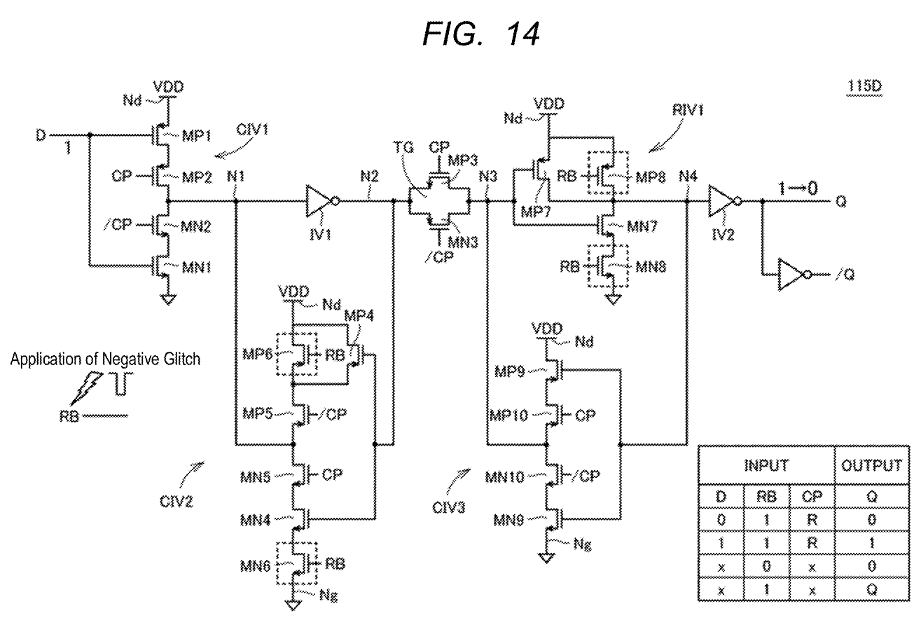

FIG. 14 is a circuit diagram illustrating a configuration example of the glitch detection F/F115D shown in FIG. 12.

Referring to FIG. 14, the glitch detection F/F115D has a configuration similar to the glitch detection F/F115A of FIG. 8. Namely, the glitch detection F/F115D includes a first stage clocked inverter CIV1 that receives the input data value (D), an inverter IV1, and a clocked inverter CIV2 with a reset function. In addition, the glitch detection F/F115D further includes a transfer gate TG, an inverter RIV1 with a reset function, a clocked inverter CIV3, and an inverter IV2. The operation of each element of the glitch detection F/F115D with respect to the clock input value (CP) and the reset input value (RB) is the same as that of the glitch detection F/F115A, so a detailed explanation will not be repeated.

Therefore, during the period when the reset signal RST is “1”, corresponding to the period when the reset input value (RB) is “0”, the P-type transistor MP8 is fixed to on, setting the output data value (Q) to “0” as the initial value.

On the other hand, during the period when the reset signal RST is “0” (reset input value (RB) is “1”), the glitch detection F/F115D operates to capture the input data value (D) at the rising edge (R) where the clock input value (CP) changes from “0” to “1”, and transfers it to the output data value (Q) during the “0” period of the next clock input value (CP). The output data value (Q) is maintained except at the rising edge (R) of the clock input value (CP).

The glitch detection F/F115D is configured such that the transistor size (W/L) is adjusted between the pair of P-type and N-type transistors, which are input to the gate with the reset input value (RB), as enclosed by the dotted line in the figure. For example, the transistor size (W/L) is adjusted in the pair of P-type transistor MP6 and N-type transistor MN6, as well as in the pair of P-type transistor MP8 and N-type transistor MN8.

Specifically, in each of these pairs, the transistor size of the P-type transistors MP6 and MP8 is designed to be larger than that of the N-type transistors MN6 and MN8. This allows the logic threshold voltage Vthy for the reset input value (SB) to be higher than the logic threshold voltage Vth (VDD/2) of a standard inverter.

This allows the glitch detection F/F115D to be designed so that it is easily initialized when the reset input value (SB) changes from “1” to “0” in response to a negative voltage glitch of the reset signal RST. As explained in FIG. 12, when the glitch detection F/F115D is initialized (data value “0”), the clock input value (C) of the holding F/F118D becomes “1”. As a result, the glitch detection signal DGLb, which is the output data value (Q) of the holding F/F118D, also changes from “0” to “1”.

As a result, by placing the glitch detection F/F115D in proximity to the secure F/F101D, it is possible to detect the negative direction glitch of the reset signal RST in the secure F/F101D with high sensitivity.

Referring again to FIG. 10, in the modified example of the first embodiment, the glitch detection circuit 110 outputs the logical OR operation result of the glitch detection signals DGLc1, DGLc2, and DGLd as the glitch detection signal DGL in FIG. 3 to the post-detection control circuit 120.

The operation of the post-detection control circuit 120 and the reset control circuit 130 thereafter is the same as in FIG. 5, so a detailed explanation will not be repeated.

Thus, even in the semiconductor device according to the modified example of the first embodiment, when a voltage fluctuation (voltage glitch) of the power supply voltage VDD or the reset signal RST is detected during the startup process of the user program, a reset process can be executed. In particular, in the configuration described in the modified example of the first embodiment, it is possible to detect with high sensitivity a voltage glitch that changes the output data value (Q) of the secure F/F101 (101C, 101D) from “1” to “0”. This enhances the security resistance against voltage glitches during user startup.

Through the first embodiment and its modified example, it is understood that voltage fluctuations (voltage glitches) in the power supply voltage VDD or the reset signal RST can be directly detected, and a reset process can be executed without depending on the initial value of the secure F/F101. As a result, the security resistance against voltage glitches during user startup can be enhanced.

### Second Embodiment

In the first embodiment, security processing during user startup was described, but similar security processing based on voltage glitch detection can also be executed after user startup.

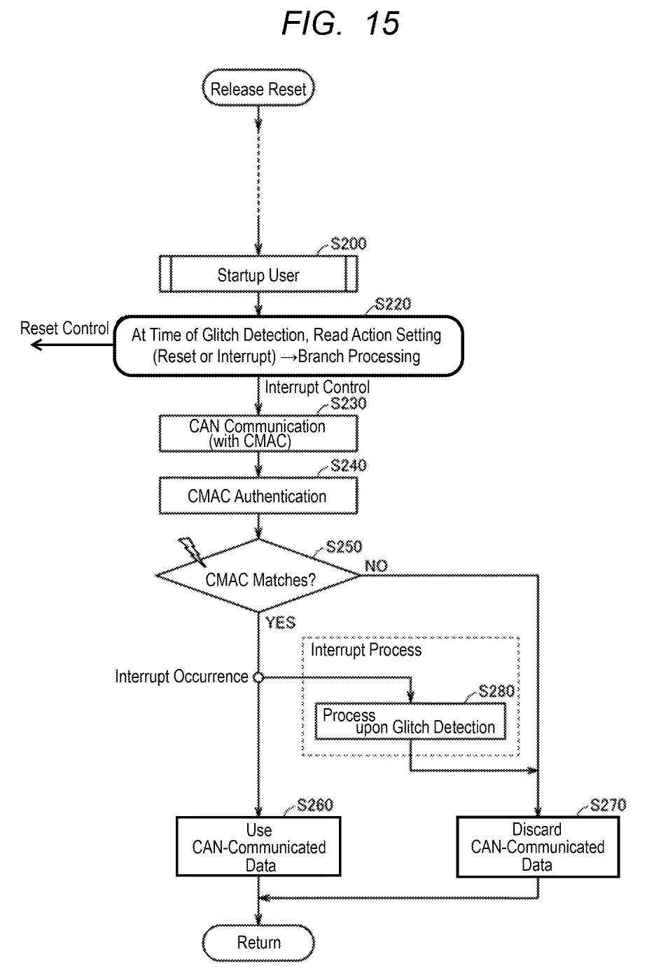

FIG. 15 is a flowchart illustrating the security processing according to the second embodiment. The flowchart of FIG. 15 is executed after the processing of S200 in FIG. 2.

After user startup by S200 (FIG. 2), the semiconductor device 100 branches the processing at the time of glitch detection between reset control and interrupt control by S220. The processing of S220 can be executed based on the read value (register value) from the action setting F/F121 (FIG. 4).

When the processing branches to “reset control” in S220, the output control of the reset signal RST described in the first embodiment is executed in response to the detection of a voltage glitch. Generally, after user startup, the holding value of the action setting F/F121 is changed by the started user program from the initial value (e.g., “0”) that enables reset control to a value (e.g., “1”) that enables interrupt control.

In the second embodiment, security processing that executes interrupt control in response to voltage glitch detection for processing requests to the processor will be described.

When the semiconductor device 100 executes a CAN (Controller Area Network) communication with a CMAC (Cipher-based Message Authentication Code) added for message authentication, which is an example of a processing request to the processor, by S230, then by S240, it executes the authentication processing by the CMAC added to the CAN communication. CMAC is a known message authentication code algorithm based on block cipher. For example, it is possible to authenticate whether the transmitted data is genuine and not falsified or tampered with, based on whether the CMAC added to the transmitted data matches the CMAC recognized by the receiving side (semiconductor device 100).

The semiconductor device 100 branches the process according to the CMAC authentication result at S250. If the authentication result is normal (CMAC match), S250 is determined as YES, and S260 allows the processor to read the CAN-communicated data. On the other hand, if the authentication result is abnormal (CMAC mismatch), S250 is determined as NO, and S270 discards the CAN-communicated data to prohibit the processor from reading it.

Furthermore, semiconductor device 100 performs voltage glitch detection similar to the first embodiment, detects an interrupt occurrence upon voltage glitch detection, and executes the process at S280 as an interrupt process. Due to this interrupt process, even if the CMAC authentication result is normal, the process proceeds to S270, the CAN-communicated data is discarded, and the processor is not allowed to read it.

Next, a configuration example of a semiconductor device according to the second embodiment for realizing the interrupt control described in FIG. 15 will be explained.

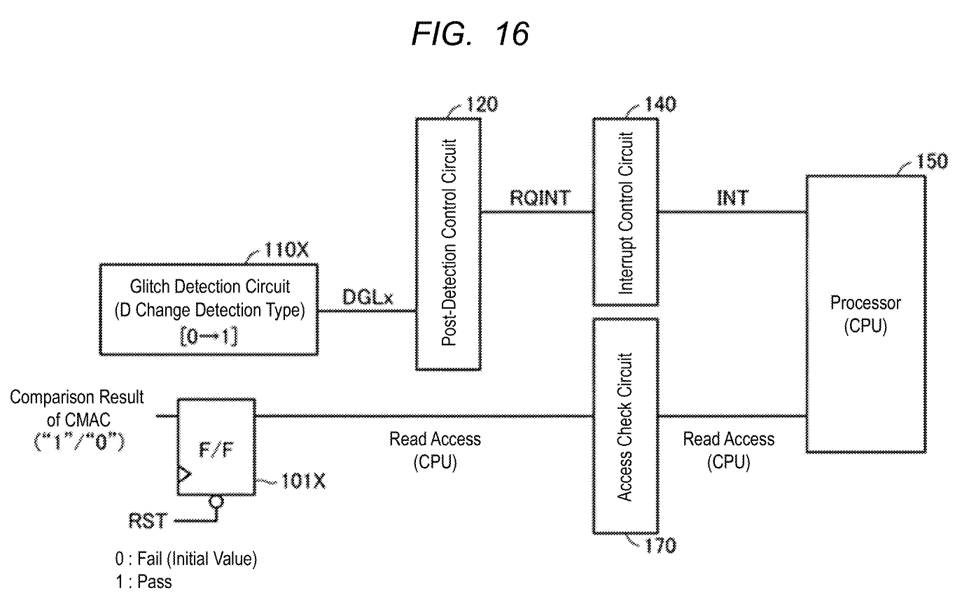

FIG. 16 is a block diagram illustrating a configuration example of a semiconductor device according to the second embodiment. Referring to FIG. 16, the semiconductor device 100 according to the second embodiment includes a secure F/F101X and a glitch detection circuit 110X for detecting the occurrence of a voltage glitch on the secure F/F101X. The secure F/F101X stores the comparison result of the CMAC. In addition, the semiconductor device 100 further includes an access check circuit 170, an interrupt control circuit 140 similar to FIG. 3, and a processor 150.

The secure F/F101X is written with a data value indicating “pass (normal)” (here, “1”) when the CMAC matches, and a data value indicating “fail (abnormal)” (here, “0”) when the CMAC does not match.

Thus, the data value stored in the secure F/F101X is “0” to indicate enabling the security function, and “1” to indicate disabling the security function.

Also, the secure F/F101X is configured such that the initial value set upon reset release is “0(fail)”. That is, the secure F/F101X is set with an initial value that enables the security function.

The access check circuit 170 controls whether to allow the read access of the processor 150 based on the output data value (Q) of the secure F/F101X. For example, when the output data value (Q) of the secure F/F101X is “1”, the read access of the processor 150 corresponding to the CAN communication is allowed, while when the output data value (Q) is “0”, the read access of the processor 150 is not allowed. This enables the processing of S240 to S270 in FIG. 15 to be realized. That is, in the second embodiment, the access check circuit 170 corresponds to an embodiment of the “check circuit” according to this disclosure.

Therefore, when the output data value of the secure F/F101X is “0”, if the output data value (Q) changes from “0” to “1” due to a voltage glitch, the processor's read access is allowed even if the CMAC does not match, thereby reducing the security function.

Therefore, a glitch detection circuit 110X for detecting voltage glitches is arranged for the secure F/F101X. Specifically, the glitch detection circuit 110X is arranged in proximity to the secure F/F101X and is configured to detect voltage glitches that cause a change from “0” to “1” in the input data value (D) to the secure F/F101X. As mentioned above, since the secure F/F101X is set with an initial value that enables the security function, there is no need to detect voltage glitches that change the reset signal RST, similar to the secure F/F101B,101D in the first embodiment.

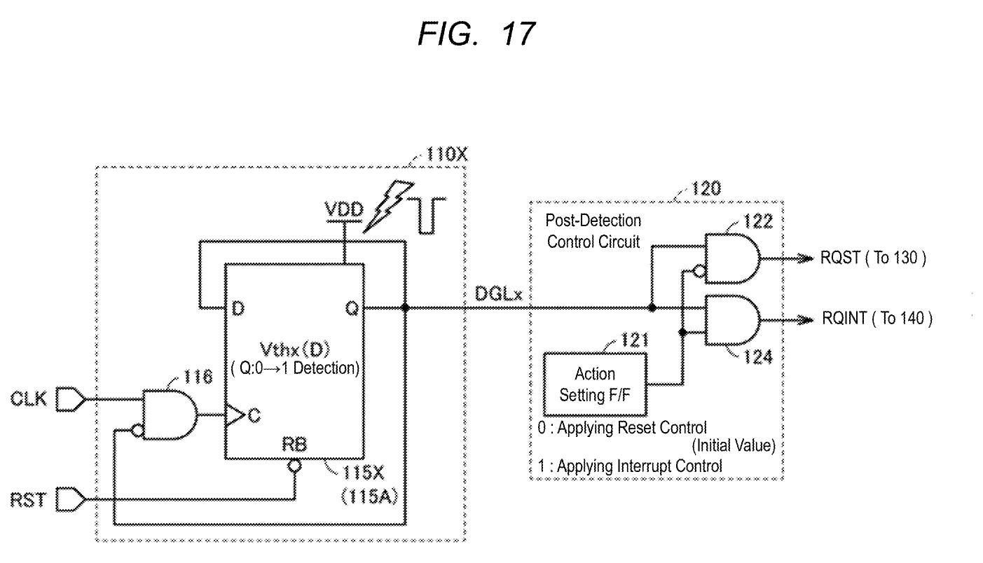

FIG. 17 is a conceptual diagram illustrating a configuration example of the glitch detection circuit 110X shown in FIG. 16.

Referring to FIG. 17, since the glitch detection circuit 110X is provided to detect a change from “0” to “1” in the input data value (D) of the secure F/F, it can be configured similarly to the glitch detection circuit 110A (FIG. 6) of the first embodiment.

That is, the glitch detection circuit 110X can be configured to detect negative glitches on the power supply voltage VDD using a glitch detection F/F115X similar to the glitch detection F/F115A (FIG. 6 and FIG. 8) and a logic gate 116. The logic gate 116 outputs the AND (logical product) operation result of the clock signal CLK and the inverted logical value of the output data value (Q), similar to FIG. 6.

In the glitch detection circuit 110X, similar to the glitch detection circuit 110A, the glitch detection F/F115X is configured to loop back connect the output data value (Q) to the input data value (D) and to use the output of the logic gate 116 as the clock input value (C). The glitch detection signal DGLc from the glitch detection circuit 110X is the same logical value as the output data value (Q) of the glitch detection F/F115X. Also, the glitch detection F/F115X is configured such that the logical threshold voltage Vthx for the input data value (D) is lower than the normal logical threshold voltage Vth (Vth=(VDD/2), similar to the glitch detection F/F115A. In the second embodiment, the glitch detection F/F115X corresponds to an embodiment of the “first flip-flop”.

The operation of the glitch detection circuit 110X is similar to that of the glitch detection circuit 110A, and after reset release, the output data value (Q) is initialized to “0”, and thereafter, the input data value (D) and the output data value (Q) are maintained at “0” by loopback connection. As a result, the glitch detection signal DGLx is also maintained at “0”.

Then, when the output data value (Q) changes to “1” in response to the occurrence of a voltage glitch, the glitch detection signal DGLx also changes to “1”. After the output data value (Q) changes to “1”, the output of the logic gate 116 is fixed at “0”, so the clock of the glitch detection F/F115X is gated. Thus, even if a voltage glitch occurs again, the output data value (Q), i.e., the glitch detection signal DGLx, does not change and is maintained at “1” until the next reset. When the glitch detection signal DGLx is set to “1”, the glitch detection circuit 110 is in a state of outputting the glitch detection signal DGL (DGLx=DGL=“1”).

The post-detection control circuit 120, as shown in FIG. 4, includes an action setting F/F121 and logic gates 122, 124. In the scenario after user activation targeted by the second embodiment, the action setting F/F121 holds a data value (“1”) to enable interrupt control.

Therefore, when the glitch detection signal DGLx is not generated from the glitch detection circuit 110X (DGLx=“0”), the post-detection control circuit 120 does not output either the reset request signal RQRST or the interrupt request signal RQINT (RQRST=RQINT=0).

In contrast, when the glitch detection signal DGLx is output from the glitch detection circuit 110X (DGLx=“1”), the post-detection control circuit 120 is in a state of outputting the interrupt request signal RQINT (RQRST=0, RQINT=1).

Referring again to FIG. 16, when the post-detection control circuit 120 generates the interrupt request signal RQINT, the interrupt control circuit 140 outputs the interrupt control signal INT to the processor (CPU) 150. As a result, an interrupt occurs for the read access allowed by the access check circuit 170, as shown in FIG. 15, and the processor (CPU) 150 can invalidate the access by discarding the CAN communication data without allowing the read access.

Thus, in the semiconductor device according to the second embodiment, it is possible to realize the interrupt process (S280) upon voltage glitch detection for the execution process of S260 at the YES determination in S250 in FIG. 15.

This allows the execution of an interrupt process to invalidate the access of the processor 150 by directly detecting voltage fluctuations (voltage glitches) on the power supply voltage VDD that change the output data value (Q) of the secure F/F101(101X) from “0” to “1” even during user program execution after user activation. This enhances security resistance against voltage glitches not only during the startup process of the user program but also after the user program has started.

### Modified Example of the Second Embodiment

Next, as a modified example of the second embodiment, a configuration for handling cases where the initial value setting of the secure F/F101X differs will be explained.

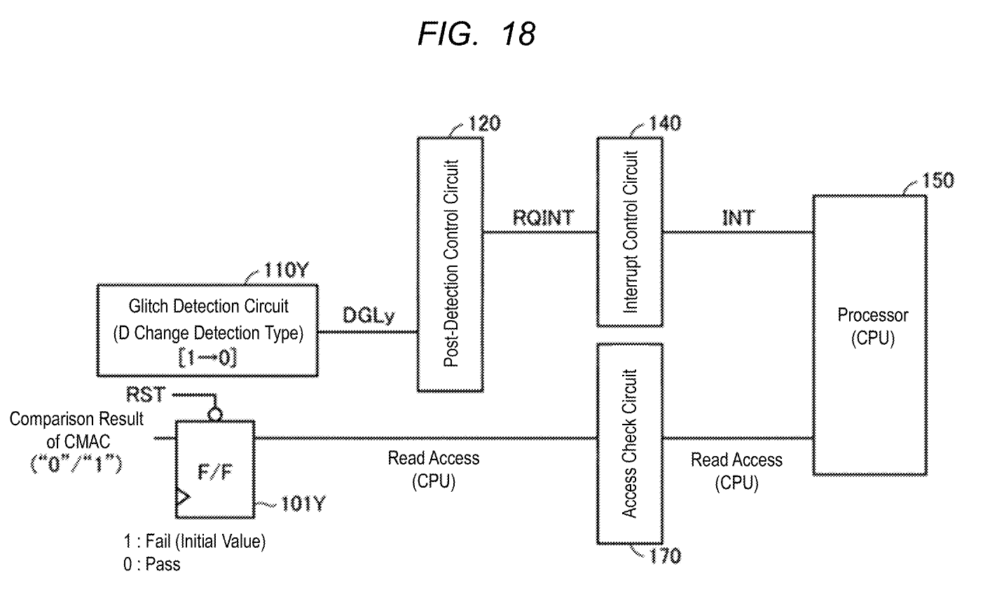

FIG. 18 is a block diagram illustrating a configuration example of a semiconductor device according to a modified example of the second embodiment.

Referring to FIG. 18, the semiconductor device according to a modified example of the second embodiment includes a secure F/F101Y and a glitch detection circuit 110Y for detecting the occurrence of a voltage glitch on the secure F/F101Y. The secure F/F101Y stores the comparison result of the CMAC. In addition, the semiconductor device according to a modified example of the second embodiment includes an access check circuit 170, an interrupt control circuit 140 similar to that in FIG. 3, and a processor 150.

That is, the semiconductor device according to a modified example of the second embodiment differs from the semiconductor device of the second embodiment in that the secure F/F101Y and glitch detection circuit 110Y are arranged instead of the secure F/F101X and glitch detection circuit 110X in FIG. 16. In the modified example of the second embodiment, other points are the same as in the second embodiment.

The secure F/F101Y, like the secure F/F101X (FIG. 16), is written with a data value indicating “pass (normal)” (here, “1”) when the CMAC matches, while a data value indicating “fail (abnormal)” (here, “0”) is written when the CMAC does not match. On the other hand, the secure F/F101Y differs from the secure F/F101X in that the initial value set at the time of reset release to enable the security function is “1”.

Therefore, in the modified example of the second embodiment, the access check circuit 170 generates a read access to the processor 150 corresponding to the CAN communication when the output data value (Q) of the secure F/F101Y is “0”, while it does not allow the read access to the processor 150 when the output data value (Q) is “1”. As a result, the processing of S240 to S270 in FIG. 15 can be realized.

Therefore, when the output data value of the secure F/F101Y is “1” and the output data value (Q) changes from “1” to “0” due to a voltage glitch attack, the processor's read access is allowed even if the CMAC does not match, thereby reducing the security function.

Therefore, a glitch detection circuit 110Y for detecting voltage glitches is arranged for the secure F/F101Y. Specifically, the glitch detection circuit 110Y is arranged in proximity to the secure F/F101Y and is configured to detect voltage glitches that cause the input data value (D) to change from “1” to “0” for the secure F/F101Y. Since the secure F/F101Y has an initial value set to enable the security function, like the secure F/F101X in the second embodiment, there is no need to detect voltage glitches that change the reset signal RST.

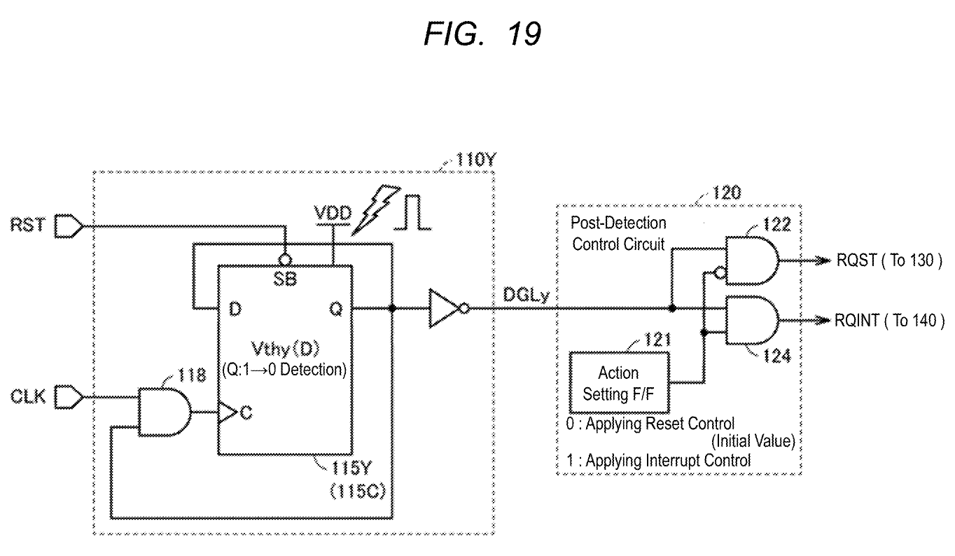

FIG. 19 is a conceptual diagram illustrating a configuration example of the glitch detection circuit 110Y shown in FIG. 18.

Referring to FIG. 19, since the glitch detection circuit 110Y is provided to detect the change of the input data value (D) of the secure F/F from “1” to “0”, it can be configured similarly to the glitch detection circuit 110C (FIG. 11) according to a modified example of the first embodiment.

That is, the glitch detection circuit 110Y can be configured to detect positive glitches on the power supply voltage VDD using a glitch detection F/F115Y similar to the glitch detection F/F115C (FIG. 11 and FIG. 13) and logic gate 118. The logic gate 118 outputs the AND (logical product) operation result of the clock signal CLK and the output data value (Q), similar to FIG. 11.

In the glitch detection circuit 110Y, as in the glitch detection circuit 110C, the glitch detection F/F115Y is configured to loop back connect the output data value (Q) to the input data value (D) and to use the output of the logic gate 118 as the clock input value (C). The glitch detection signal DGLy from the glitch detection circuit 110Y has the inverted logical value of the output data value (Q) of the glitch detection F/F115X. Also, the glitch detection F/F115Y is configured such that the logical threshold voltage Vthy for the input data value (D) is higher than the normal logical threshold voltage Vth (Vth=(VDD/2)), similar to the glitch detection F/F115C. In the modified example of the second embodiment, the glitch detection F/F115Y corresponds to an embodiment of the “first flip-flop”.

The operation of the glitch detection circuit 110Y is similar to that of the glitch detection circuit 110C, and after the reset is released, the output data value (Q) is initialized to “1”, and thereafter, the input data value (D) and the output data value (Q) are maintained at “1” by loopback connection.

Then, when the output data value (Q) changes to “0” in response to the occurrence of a voltage glitch, the glitch detection signal DGLx also changes to “1”. After the output data value (Q) changes to “0”, the output of the logic gate 118 is fixed to “0”, so the clock of the glitch detection F/F115Y is gated, and even if a voltage glitch occurs again, the output data value (Q) does not change and is maintained at “0” until the next reset.

Therefore, the glitch detection signal DGLy, which has the inverted logical value of the output data value (Q), is initialized to “0” after the reset is released, and changes from “0” to “1” when a voltage glitch (positive voltage fluctuation of the power supply voltage VDD) is detected. On the other hand, the glitch detection signal DGLy is maintained at “0” until a voltage glitch is detected after the reset is released and is maintained at “1” until the next reset after the voltage glitch is detected. When the glitch detection signal DGLy is set to “1”, the glitch detection circuit 110 is in a state of outputting the glitch detection signal DGL (DGLy=DGL=“1”). In the modified example of the second embodiment, the operation of the semiconductor device after the glitch detection signal DGLy is output (set to DGLy=“1”) is the same as the operation of the semiconductor device after the glitch detection signal DGLx is output (set to DGLx=“1”) in the second embodiment, so detailed explanation is not repeated.

Therefore, in the semiconductor device according to the modified example of the second embodiment, it is possible to realize the interrupting processing (S280) at the time of voltage glitch detection for the execution processing of S260 at the time of YES determination in S250 in FIG. 15.

As a result, even during the execution of the user program after user activation, it is possible to directly detect voltage fluctuations (voltage glitches) on the power supply voltage VDD that change the output data value (Q) of the secure F/F101 (101Y) from “1” to “0”, and execute interrupt processing to invalidate the access of the processor 150.

That is, through the second embodiment and its modified example, it is understood that interrupt processing to invalidate the access of the processor 150 can be executed when a voltage glitch is detected, regardless of the initial value (after reset release) of the secure F/F101 (101X, 101Y). As a result, it is possible to enhance security resistance against voltage glitches not only during the startup process of the user program but also after the startup of the user program.

In the second embodiment and its modified example, an example was described in which voltage glitches on the secure F/F101X, 101Y holding the security check result for CAN communication are detected and interrupt processing is executed. However, in the semiconductor device according to the present disclosure, it is possible to arrange a similar glitch detection circuit for the secure F/F101 holding other security check results. Furthermore, it is possible to execute interrupt processing to invalidate the access processing in response to the detection of voltage fluctuations on elements related to the processing, not limited to read access for data by CAN communication, but for any access processing of the processor 150.

Regarding the multiple embodiments described above, it is confirmatively stated that it is intended from the beginning of the application to appropriately combine the configurations described in each embodiment within a range where inconsistencies or contradictions do not occur, including combinations not mentioned in the specification.

Although the invention made by the inventor has been specifically described based on the embodiment, the present invention is not limited to the embodiment, and it is needless to say that various modifications can be made without departing from the gist thereof.

What is claimed is:

1. A semiconductor device including a processor, comprising:
a glitch detection circuit that outputs a glitch detection signal when a voltage fluctuation is detected; and
a control circuit that outputs a reset request signal of the semiconductor device or an interrupt request signal for processing of the processor when the glitch detection signal is output from the glitch detection circuit,
wherein the glitch detection circuit includes a voltage fluctuation detection circuit that outputs a first value in an initial state after reset release and changes the output from the first value to a second value when the voltage fluctuation is detected, and is configured to output the glitch detection signal when the voltage fluctuation detection circuit outputs the second value.

2. The semiconductor device according to claim 1, further comprising:
a data retention circuit configured to store a data value indicating whether a security function is enabled or disabled; and
a check circuit for controlling a reset of the semiconductor device or access of the processor based on an output data value of the data retention circuit,
wherein the voltage fluctuation detection circuit is arranged in a layout that receives the same voltage fluctuation as the data retention circuit.

3. The semiconductor device according to claim 2,
wherein the data retention circuit is configured to store the data value indicating the execution instruction of secure boot or the execution result of the secure boot at the time of user program startup,
wherein the check circuit is configured to output the reset request signal based on the output data value of the data retention circuit at the time of user program startup,
wherein the control circuit is configured to output the reset request signal when the glitch detection signal is output from the glitch detection circuit at the time of user program startup, and
wherein the semiconductor device further comprises a reset control circuit that outputs a reset signal within the semiconductor device when the reset request signal is output from the check circuit or the control circuit.

4. The semiconductor device according to claim 2,
wherein the data retention circuit is configured to store the data value indicating permission or denial of the processing for the processor,
wherein the check circuit controls the permission or denial of access for the processing based on the output data value of the data retention circuit,
wherein the control circuit is configured to output the interrupt request signal when the glitch detection signal is output from the glitch detection circuit after the user program startup, and
wherein the semiconductor device further includes an interrupt control circuit that executes interrupt processing to invalidate the access by the processing for the processor when the interrupt request signal is output from the control circuit.

5. The semiconductor device according to claim 2,
wherein the data retention circuit is configured such that the data value indicating the disabling of the security function is set as the initial value after releasing a reset state,
wherein the voltage fluctuation detection circuit comprises:
a first flip-flop circuit configured to change the output data value from the first value to the second value when voltage fluctuation occurs in the input data value, operates with the common power supply voltage and reset signal of the data retention circuit; and
a second flip-flop circuit configured to change the output data value from the first value to the second value when voltage fluctuation occurs in the reset input value or set input value.

6. The semiconductor device according to claim 2,
wherein the data retention circuit is configured such that the data value indicating the enabling of the security function is set as the initial value after releasing a reset state, and
wherein the voltage fluctuation detection circuit operates with the common power supply voltage and reset signal of the data retention circuit and includes a first flip-flop circuit configured to change the output data value from the first value to the second value when voltage fluctuation occurs in the input data value.

7. The semiconductor device according to claim 5,
wherein the data retention circuit is configured to store the data value as a logical low-level value indicating the enabling of the security function or a logical high-level value indicating the disabling of the security function,
wherein each of the first flip-flop circuit and the second flip-flop circuit is configured such that the first value becomes the logical low-level value, and the second value becomes the logical high-level value.

8. The semiconductor device according to claim 5,
wherein the data retention circuit is configured to store the data value as a logical high-level value indicating the enabling of the security function or a logical low-level value indicating the disabling of the security function, and
wherein each of the first flip-flop circuit and the second flip-flop circuit is configured such that the first value becomes the logical high-level value, and the second value becomes the logical low-level value.

9. The semiconductor device according to claim 6,
wherein the data retention circuit is configured to store the data value as a logical low-level value indicating the enabling of the security function or a logical high-level value indicating the disabling of the security function,
wherein the first flip-flop circuit is configured such that the first value becomes the logical low-level value, and the second value becomes the logical high-level value.

10. The semiconductor device according to claim 6,
wherein the data retention circuit is configured to store the data value as a logical high-level value indicating the enabling of the security function or a logical low-level value indicating the disabling of the security function, and
wherein the first flip-flop circuit is configured such that the first value becomes the logical high-level value, and the second value becomes the logical low-level value.
